(19) United States
(12) Patent Application Publication
(10) Pub. No.: US 2026/0221994 A1
(43) Pub. Date: Jul. 30, 2026

(54) ELECTRONIC DEVICE AND CONTROL METHOD FOR ELECTRONIC DEVICE

(71) Applicant: Sony Semiconductor Solutions Corporation, Kanagawa (JP)

(72) Inventor: Yasuhiro Ochiai, Kanagawa (JP)

(21) Appl. No.: 19/141,858

(22) PCT Filed: Jan. 10, 2024
(86) PCT No.: PCT/JP2024/000222

§ 371 Date: Jun. 20, 2025

(30) Foreign Application Priority Data
Feb. 13, 2023 (JP) 2023-019803

(51) Int. Cl. H04B 1/10; G06F 13/42; G06F 21/44; H01Q 1/22; H04B 17/20; H04L 25/02

(52) U.S. Cl. CPC H04B 1/10; G06F 13/4221; G06F 21/44; H01Q 1/22; H04B 17/201; H04L 25/0272; G06F 2213/0026

(57) ABSTRACT

Electronic devices with built-in components including an antenna and transmission lines, with electromagnetic interference suppression are disclosed. In one example, an electronic device includes an antenna, a plurality of transmission lines, and a control unit. In the electronic device including the antenna, the plurality of transmission lines, and the control unit, signals are transmitted through the plurality of transmission lines. Furthermore, in the electronic device including the antenna, the plurality of transmission lines, and the control unit, the control unit controls the directivity of electromagnetic waves radiated from the plurality of transmission lines on the basis of the reception performance of the antenna.

### TECHNICAL FIELD

The present technology relates to an electronic device. Specifically, the present technology relates to an electronic device that transmits a signal within the device, and a control method for an electronic device.

### BACKGROUND ART

For signal transmission within electronic devices, various known standards such as mobile industry processor interface (MIPI) and peripheral component interconnect express (PCIe) are used. Among these, under the MIPI standard, a differential signal is transmitted through each lane, which serves as a transmission line. For example, a device that individually adjusts the delay times of a plurality of signals constituting the differential signal has been proposed (see, for example, Patent Document 1).

### CITATION LIST

### Patent Document

Patent Document 1: WO 2022/130880 A

### SUMMARY OF THE INVENTION

### Problems to be Solved by the Invention

The known standard described above is designed to reduce common-mode noise by adjusting the delay times of the plurality of signals constituting the differential signal. However, in a case where a built-in antenna is located near the transmission line, the transmission line may act as a source of noise, causing electromagnetic interference between the transmission line and the antenna. This phenomenon is called intra electromagnetic compatibility (EMC) or radio frequency interference (RFI). This electromagnetic interference poses a problem that degrades the reception performance of the antenna.

The present technology has been made in view of such circumstances, and it is therefore an object of the present technology to suppress electromagnetic interference in an electronic device with built-in components including an antenna and transmission lines.

### Solutions to Problems

The present technology has been made to solve the above-described problems, and a first aspect thereof includes an electronic device and a control method for the electronic device, the electronic device including an antenna, a plurality of transmission lines through which signals are transmitted, and a control unit that controls directivity of electromagnetic waves radiated from the plurality of transmission lines on the basis of reception performance of the antenna. This brings about an effect of suppressing electromagnetic interference.

Furthermore, according to the first aspect, a first drive unit that outputs a first output signal, a second drive unit that outputs a second output signal, a first transmission-side delay circuit that delays output of the first output signal, and a second transmission-side delay circuit that delays output of the second output signal may be further included, the plurality of transmission lines may include a first transmission line through which the first output signal is transmitted, and a second transmission line through which the second output signal is transmitted, and the control unit may adjust a delay time of each of the first and second transmission-side delay circuits. This brings about an effect of controlling the directivity through delay time adjustment.

Furthermore, according to the first aspect, each of the first and second transmission-side delay circuits may include multi-stage delay elements that generate a plurality of delay signals with different delay times, and a selector that selects and outputs either a clock signal or one of the plurality of delay signals. This brings about an effect of controlling the delay time of each transmission line.

Furthermore, according to the first aspect, each of the first and second transmission-side delay circuits may include a logic circuit that outputs a signal obtained by delaying a clock signal, a plurality of first transistors connected in parallel between a power supply terminal of the logic circuit and a power supply node, and a plurality of second transistors connected in parallel between a ground terminal of the logic circuit and a ground node, and the control unit may control the number of the first transistors in an ON state and the number of the second transistors in the ON state. This brings about an effect of controlling the delay time of each transmission line.

Furthermore, according to the first aspect, each of the first and second transmission-side delay circuits may include a logic circuit that delays and outputs a clock signal, a first transistor inserted between a power supply terminal of the logic circuit and a power supply node, a second transistor inserted between a ground terminal of the logic circuit and a ground node, a first bias voltage generation circuit that generates a first bias voltage and supplies the first bias voltage to a gate of the first transistor, and a second bias voltage generation circuit that generates a second bias voltage and supplies the second bias voltage to a gate of the second transistor, and the control unit may control each of the first and second bias voltages. This brings about an effect of controlling the delay time of each transmission line.

Furthermore, according to the first aspect, a communication standard applied to the plurality of transmission lines may include a mobile industry processor interface (MIPI) C-PHY standard. This brings about an effect of transmitting the differential signal using the clock-embedded method.

Furthermore, according to the first aspect, a first reception-side delay circuit that delays and outputs the first output signal as a first delay signal, a second reception-side delay circuit that delays and outputs the second output signal as a second delay signal, a first receiver circuit that receives the first delay signal, and a second receiver circuit that receives the second delay signal may be further included, and the control unit may further adjust a delay time of each of the first and second reception-side delay circuits. This brings about an effect of resetting the delay time on the reception side.

Furthermore, according to the first aspect, a communication standard applied to the plurality of transmission lines may include a MIPI D-PHY standard. This brings about an effect of transmitting the clock signal and data signal.

Furthermore, according to the first aspect, the control unit may include a transmission-side control unit that adjusts the delay time of each of the first and second transmission-side delay circuits and supplies a control signal related to the delay time, and a reception-side control unit that adjusts the delay time of each of the first and second reception-side delay circuits on the basis of the control signal. This brings about an effect of adjusting the delay time using the control units on both the transmission side and the reception side.

Furthermore, according to the first aspect, each of the first and second reception-side delay circuits may include a delay locked loop (DLL). This brings about an effect of controlling the delay time of each transmission line.

Furthermore, according to the first aspect, an edge inversion determination circuit that determines whether or not a sign of a phase difference between an edge of the first delay signal and an edge of the second delay signal has been inverted and outputs a determination result may be further included, and the reception-side control unit may adjust the delay time of each of the first and second reception-side delay circuits on the basis of the control signal and the determination result. This brings about an effect of resetting the delay time with high accuracy.

Furthermore, according to the first aspect, a communication standard applied to the plurality of transmission lines may include a standard applied to transmission of differential signals or single-ended signals. This brings about an effect of suppressing electromagnetic interference when the differential signal or single-ended signal is transmitted.

Furthermore, according to the first aspect, the communication standard applied to transmission of the differential signals may include peripheral component interconnect express (PCIe), and the communication standard applied to transmission of the single-ended signals may include double data rate (DDR). This brings about an effect of suppressing electromagnetic interference when PCIe or DDR is used.

Furthermore, according to the first aspect, the plurality of transmission lines may include a predetermined number of first transmission lines through which signals are transmitted from a first chip to the control unit, and a predetermined number of second transmission lines through which signals are transmitted from a second chip to the control unit. This brings about an effect of suppressing electromagnetic interference in a device equipped with a plurality of chips.

Furthermore, according to the first aspect, output timings of the signals transmitted through each of the predetermined number of first transmission lines may be identical, output timings of the signals transmitted through each of the predetermined number of second transmission lines may be identical, and the control unit may adjust a delay time of the output timings of either the first transmission lines or the second transmission lines relative to the other transmission lines. This brings about an effect of appropriately controlling the delay times of the plurality of transmission lines.

Furthermore, according to the first aspect, the control unit may individually adjust a delay time of the signals transmitted through each of the predetermined number of first transmission lines and the predetermined number of second transmission lines. This brings about an effect of appropriately controlling the delay times of the plurality of transmission lines.

Furthermore, according to the first aspect, output timings of the signals transmitted through each of the predetermined number of second transmission lines may be identical, and the control unit may individually control a delay time of the output timings and a delay time of the signals transmitted through each of the predetermined number of first transmission lines. This brings about an effect of appropriately controlling the delay times of the plurality of transmission lines.

Furthermore, according to the first aspect, the first chip may transmit a first authentication key, the second chip may transmit a second authentication key, and the control unit may authenticates each of the first and second chips on the basis of whether or not each of the first and second authentication keys matches a third authentication key, and control directivity of electromagnetic waves radiated from transmission lines corresponding to a chip that has been successfully authenticated. This brings about an effect of enabling chips with various configurations to coexist.

Furthermore, according to the first aspect, a rewritable third storage unit that stores the third authentication key may be further included, the first chip may include a rewritable first storage unit that stores the first authentication key, and the second chip may include a rewritable second storage unit that stores the second authentication key. This brings about an effect of enabling the addition and update of authentication keys.

### BRIEF DESCRIPTION OF DRAWINGS

FIG. 1 is an example of a rear view of an electronic device according to a first embodiment of the present technology.

FIG. 2 is a plan view illustrating an example of an internal structure of a casing according to the first embodiment of the present technology.

FIG. 3 is a diagram illustrating a configuration example of a camera module according to the first embodiment of the present technology.

FIG. 4 is a block diagram illustrating a configuration example of the electronic device according to the first embodiment of the present technology.

FIG. 5 is a diagram illustrating an example of wiring within each lane according to the first embodiment of the present technology.

FIG. 6 is a block diagram illustrating a configuration example of a sensor chip and a System-on-a-Chip (SoC) according to the first embodiment of the present technology.

FIG. 7 is a block diagram illustrating a configuration example of a drive unit according to the first embodiment of the present technology.

FIG. 8 is a circuit diagram illustrating a configuration example of a delay circuit according to the first embodiment of the present technology.

FIG. 9 is an example of an enlarged view of a flexible printed circuits (FPC) cable according to the first embodiment of the present technology.

FIG. 10 is a graph showing an example of frequency characteristics of each lane in the initial state according to the first embodiment of the present technology.

FIG. 11 is a diagram showing an example of a frequency spectrum of each of Lanes 0 and 1 according to the first embodiment of the present technology.

FIG. 12 is a diagram showing an example of a frequency spectrum of Lane 2 according to the first embodiment of the present technology.

FIG. 13 is a diagram illustrating an example of coordinate axes and radiated electric field according to the first embodiment of the present technology.

FIG. 14 is a diagram showing an example of radiation characteristics of electromagnetic waves at a radio frequency of 750 megahertz (MHz) according to the first embodiment of the present technology.

FIG. 15 is a diagram showing an example of radiation characteristics of electromagnetic waves at a radio frequency of 1250 megahertz (MHz) according to the first embodiment of the present technology.

FIG. 16 is a diagram showing an example of radiation characteristics of electromagnetic waves at a radio frequency of 1750 megahertz (MHz) according to the first embodiment of the present technology.

FIG. 17 is a diagram showing an example of radiated electric field at each frequency according to the first embodiment of the present technology.

FIG. 18 is a flowchart illustrating an example of operation of the electronic device according to the first embodiment of the present technology.

FIG. 19 is a diagram illustrating an example of directivity of electromagnetic waves before and after delay time adjustment according to the first embodiment of the present technology.

FIG. 20 is a diagram showing an example of a waveform of a differential signal in the initial state according to the first embodiment of the present technology.

FIG. 21 is a diagram showing an example of a waveform of a differential signal after delay time adjustment according to the first embodiment of the present technology.

FIG. 22 is a circuit diagram illustrating a configuration example of a delay circuit according to a second embodiment of the present technology.

FIG. 23 is a circuit diagram illustrating a configuration example of a delay circuit according to a third embodiment of the present technology.

FIG. 24 is a block diagram illustrating a configuration example of a sensor chip and a SoC according to a fourth embodiment of the present technology.

FIG. 25 is a diagram illustrating an example of a delay time on the reception side according to the fourth embodiment of the present technology.

FIG. 26 is a block diagram illustrating a configuration example of a sensor chip and a SoC according to a fifth embodiment of the present technology.

FIG. 27 is a circuit diagram illustrating a configuration example of a delay circuit according to the fifth embodiment of the present technology.

FIG. 28 is a diagram showing an example of a waveform of a differential signal after delay time adjustment according to the fifth embodiment of the present technology.

FIG. 29 is a diagram illustrating an example of a delay time of a delay circuit on the reception side according to the fifth embodiment of the present technology.

FIG. 30 is a block diagram illustrating a configuration example of a SoC according to a sixth embodiment of the present technology.

FIG. 31 is a block diagram illustrating a configuration example of an edge inversion determination circuit according to the sixth embodiment of the present technology.

FIG. 32 is a circuit diagram illustrating a configuration example of a pulse generation circuit according to the sixth embodiment of the present technology.

FIG. 33 is a flowchart illustrating an example of operation of an electronic device according to the sixth embodiment of the present technology.

FIG. 34 is a flowchart illustrating an example of delay time compensation processing according to the sixth embodiment of the present technology.

FIG. 35 is a block diagram illustrating a configuration example of an electronic device according to a seventh embodiment of the present technology.

FIG. 36 is a timing chart illustrating an example of a delay time adjustment method according to the seventh embodiment of the present technology.

FIG. 37 is a timing chart illustrating an example of the delay time adjustment method according to the seventh embodiment of the present technology.

FIG. 38 is a timing chart illustrating an example of the delay time adjustment method according to the seventh embodiment of the present technology.

FIG. 39 is a flowchart illustrating an example of operation of an electronic device according to a first modification of the seventh embodiment of the present technology.

FIG. 40 is a block diagram of each of a sensor chip and a SoC according to a second modification of the seventh embodiment of the present technology.

FIG. 41 is a diagram illustrating a case where the SoC transmits an authentication key according to the second modification of the seventh embodiment of the present technology.

FIG. 42 is a block diagram illustrating a schematic configuration example of a vehicle control system.

FIG. 43 is an explanatory diagram illustrating an example of installation positions of imaging sections.

### MODE FOR CARRYING OUT THE INVENTION

Modes for carrying out the present technology (hereinafter, referred to as embodiments) will be described below. The description will be given in the following order.
1. First embodiment (example of adjusting delay time of each lane)
2. Second embodiment (example of adjusting delay time of each lane through control of transistor size)
3. Third embodiment (example of adjusting delay time of each lane through control of bias voltage)
4. Fourth embodiment (example of adjusting delay time of each lane on transmission side and resetting delay time on reception side)
5. Fifth embodiment (example of adjusting delay time of each lane using transmission-side control unit and resetting delay time on reception side)
6. Sixth embodiment (example of adjusting delay time of each lane on transmission side and determining whether or not edge relationship is inverted on reception side)
7. Seventh embodiment (example of adjusting delay time of lane provided between a plurality of chips)
8. Example of application to mobile entity

### 1. First Embodiment

### [Configuration Example of Electronic Device]

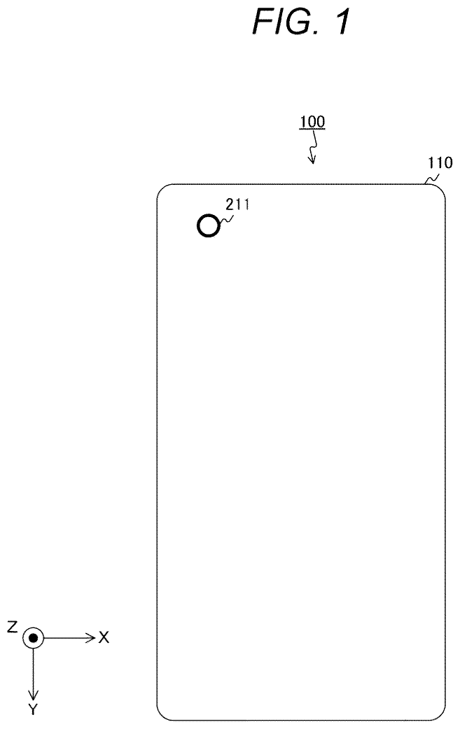

FIG. 1 is an example of a rear view of an electronic device 100 according to the first embodiment of the present technology. For example, a smartphone is considered as an example of the electronic device 100. The electronic device 100 includes a casing 110. A side of the casing 110 on which a display device (not illustrated) is installed is defined as a front side of the electronic device 100, and a rear camera including a lens 211 is placed on a back side as opposed to the front side.

Hereinafter, a predetermined axis parallel to the back side of the casing 110 is defined as an “X axis”, a predetermined axis orthogonal to the back side is defined as a “Z axis”, and an axis orthogonal to the X axis and the Z axis is defined as a “Y axis”.

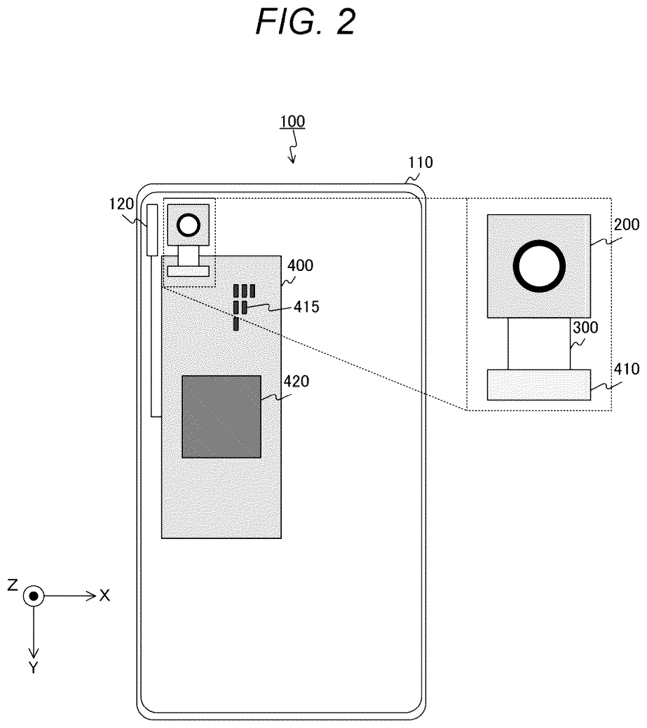

FIG. 2 is a plan view illustrating an example of an internal structure of the casing 110 according to the first embodiment of the present technology. In the casing 110, an antenna 120, a camera module 200, and a main board 400 are placed. The main board 400 is equipped with a connector 410, a predetermined number of discrete components 415, and a SoC 420. Furthermore, the camera module 200 and the connector 410 are electrically connected through an FPC cable 300.

The antenna 120 transmits and receives electromagnetic waves to and from the outside. The antenna 120 is placed near the FPC cable 300. Furthermore, the antenna 120 converts an electromagnetic wave received from the outside into an electric signal and transmits the electric signal to the SoC 420, and converts an electric signal received from the SoC 420 into an electromagnetic wave and transmits the electromagnetic wave to the outside.

The camera module 200 generates image data through photoelectric conversion. The camera module 200 supplies the image data to the SoC 420 through the FPC cable 300 and signal lines (not illustrated) in the main board 400.

The FPC cable 300 contains a plurality of transmission lines (not illustrated) for transmitting image data and control signals.

The SoC 420 controls various devices (such as the antenna 120 and the camera module 200) installed in the electronic device 100.

Note that, while the smartphone has been given as an example of the electronic device 100, the electronic device 100 is not limited to smartphones as long as it incorporates an antenna and transmission lines. The electronic device 100 may be, for example, a laptop computer or an in-vehicle device.

### [Configuration Example of Camera Module]

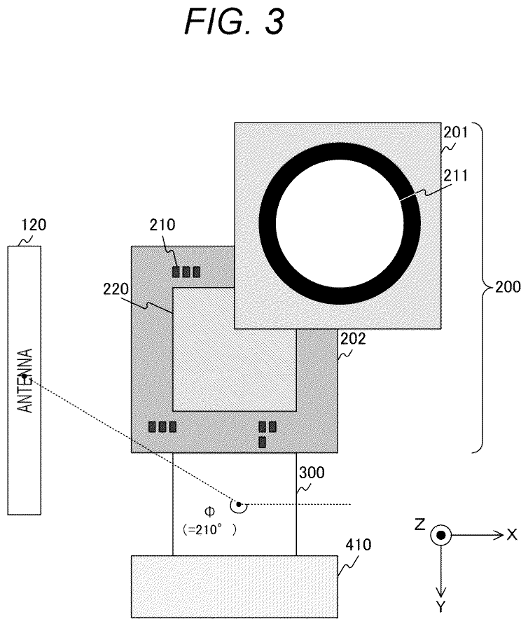

FIG. 3 is a diagram illustrating a configuration example of the camera module 200 according to the first embodiment of the present technology. The camera module 200 includes a module head 201 and a module board 202. On the module head 201, the lens 211 and an actuator (not illustrated) that drives the lens 211 are placed.

On the module board 202, a sensor chip 220 and a predetermined number of discrete components 210 are placed. The sensor chip 220 functions as, for example, a solid-state imaging element to generate image data and transmit the image data to the SoC 420 through the FPC cable 300.

Furthermore, in the XY plane, an angle formed by the X axis and a direction from a predetermined position (such as a center position) on the FPC cable 300 to a predetermined position on the antenna 120 located near the FPC cable 300 is denoted as φ, φ being 210°, for example. Furthermore, the height of the antenna 120 from the front side of the casing is approximately equal to that of the FPC cable 300.

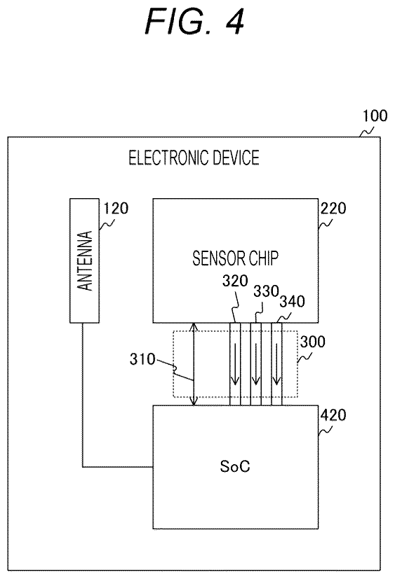

FIG. 4 is a block diagram illustrating a configuration example of an electronic device 100 according to the first embodiment of the present technology. Transmission lines 310, 320, 330, and 340 are laid between the sensor chip 220 and the SoC 420. The FPC cable 300 includes these transmission lines. The transmission line 310 is used to transmit control signals at a low communication speed compared to the transmission lines 320, 330, and 340. As the communication standard applied to the transmission line 310, for example, the inter-integrated circuit (I2C) standard is used.

The transmission lines 320, 330, and 340 are used to transmit image data at a high communication speed compared to the transmission line 310. As the communication standard applied to these transmission lines 320, 330, and 340, for example, the MIPI C-PHY standard is used.

Under the MIPI C-PHY standard, the transmission lines 320, 330, and 340 are each used as a lane. Each of the lanes transmits signals using a three-wire differential transmission method. Hereinafter, the transmission line 320 is denoted as Lane 0, the transmission line 330 is denoted as Lane 1, and the transmission line 340 is denoted as Lane 2. Furthermore, under the MIPI C-PHY standard, a clock-embedded method for transmitting data signals with embedded clock signals is used.

Note that the I2C and MIPI C-PHY standards are used for transmission of control signals and image data, respectively, but different communication standards can also be used. For example, instead of the MIPI C-PHY standard, the MIPI D-PHY standard to be described later, a different communication standard (such as PCIe) for transmitting differential signals, or a communication standard for transmitting single-ended signals (such as double data rate (DDR)) can be used.

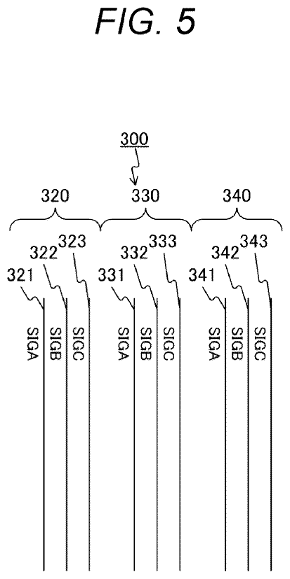

FIG. 5 is a diagram illustrating an example of wiring within each lane according to the first embodiment of the present technology. In Lane 0 (transmission line 320), signal lines 321, 322, and 323 are laid. In Lane 1 (transmission line 330), signal lines 331, 332, and 333 are laid. In Lane 2 (transmission line 340), signal lines 341, 342, and 343 are laid. Signals transmitted through the three lines in each lane are denoted as SIGA, SIGB, and SIGC.

Note that two of the transmission lines 320, 330, and 340 are examples of the first and second transmission lines recited in the claims.

### [Configuration Example of Chip]

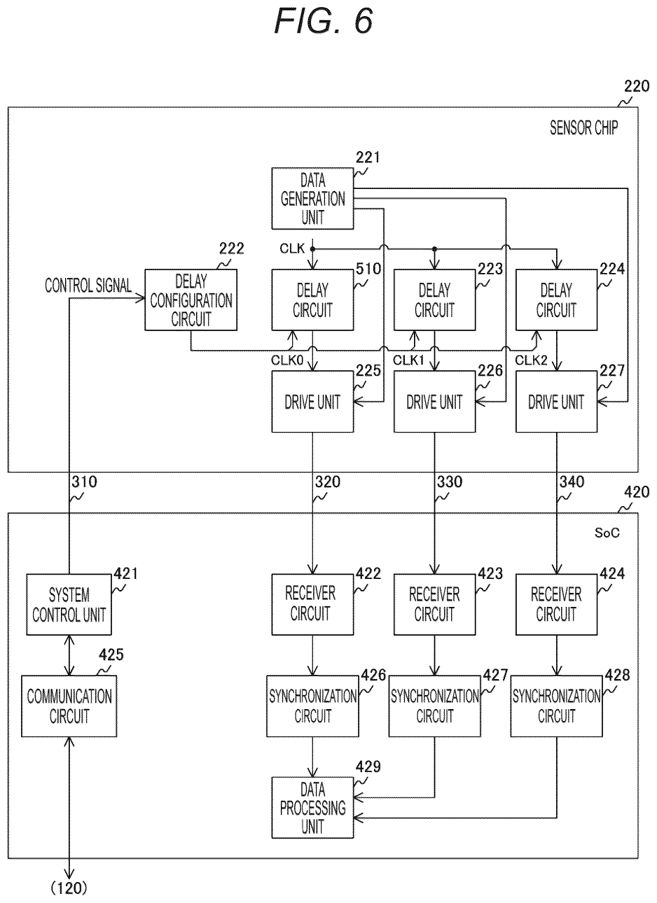

FIG. 6 is a block diagram illustrating a configuration example of the sensor chip 220 and the SoC 420 according to the first embodiment of the present technology. The sensor chip 220 includes a data generation unit 221, a delay configuration circuit 222, a delay circuit 510, a delay circuit 223, a delay circuit 224, a drive unit 225, a drive unit 226, and a drive unit 227.

The data generation unit 221 generates parallel data and supplies the parallel data to each of the drive units 225, 226, and 227.

The delay configuration circuit 222 sets the delay time of each of the delay circuits 510, 223, and 224. The delay configuration circuit 222 receives a control signal from the SoC 420 through the transmission line 310 based on the I2C standard. The control signal includes information indicating the delay time of each of the delay circuits 510, 223, and 224. The delay configuration circuit 222 sets the delay time in accordance with the control signal.

The delay circuit 510 delays a clock signal CLK and supplies the resultant signal to the drive unit 225 as a clock signal CLK0. The delay circuit 223 delays the clock signal CLK and supplies the resultant signal to the drive unit 226 as a clock signal CLK1. The delay circuit 224 delays the clock signal CLK and supplies the resultant signal to the drive unit 227 as a clock signal CLK2. Note that the delay circuits 510 and 223 are examples of the first and second transmission-side delay circuits recited in the claims.

In synchronization with the clock signal CLK0, the drive unit 225 converts the parallel data into serial data and transmits the serial data to the SoC 420 through Lane 0 (transmission line 320) using the differential transmission method. In synchronization with the clock signal CLK1, the drive unit 226 converts the parallel data into serial data and transmits the serial data to the SoC 420 through Lane 1 (transmission line 330) using the differential transmission method. In synchronization with the clock signal CLK2, the drive unit 227 converts the parallel data into serial data and transmits the serial data to the SoC 420 through Lane 2 (transmission line 340) using the differential transmission method. Note that the drive units 225 and 226 are examples of the first and second drive units recited in the claims.

As described above, by delaying the clock signal of each lane, it is possible to delay the signal transmitted in synchronization with the clock signal. Furthermore, through the delay control, the SoC 420 can independently control the delay time of each lane. All the delay times of Lanes 0, 1, and 2 may be different, or two of the three may be identical.

Furthermore, the SoC 420 includes a system control unit 421, a receiver circuit 422, a receiver circuit 423, a receiver circuit 424, a synchronization circuit 426, a synchronization circuit 427, a synchronization circuit 428, a communication circuit 425, and a data processing unit 429.

The system control unit 421 controls the entire SoC 420. Here, it is assumed that either a test mode for delay time adjustment or a normal mode other than the test mode is enabled in the electronic device 100.

As described above, since the antenna 120 is placed near the three lanes, electromagnetic interference (EMI) caused by electric field radiated from these lanes may couple with the antenna 120. When the antenna 120 receives weak radio waves from the outside, EMI interferes with the reception of the radio waves. That is, the wireless sensitivity of the antenna 120 degrades. In particular, the faster the speed of communication through the FPC cable 300, or the longer the FPC cable 300, the greater the electromagnetic field radiation. Furthermore, the shorter the distance between the FPC cable 300 and the antenna 120, the greater the degradation of the wireless sensitivity. Furthermore, since radiated electric field peaks are likely to appear in the harmonics of the clock signal used in the MIPI standard, in a case where their frequencies overlap with the frequency band used for wireless communication, the wireless sensitivity is prone to degradation.

Therefore, in the test mode, an attempt is made to solve this problem by performing the delay time adjustment. Note that it is also possible to perform the delay time adjustment in the dynamic normal mode.

When the test mode is enabled, the system control unit 421 transmits a request for transmission of a predetermined test signal to the outside through the communication circuit 425 and the antenna 120.

The antenna 120 receives the test signal, and the communication circuit 425 supplies received data of the test signal to the system control unit 421. On the basis of the received data, the system control unit 421 measures a parameter indicating the reception performance of the antenna 120. As the parameter, the wireless sensitivity, the level of antenna coupling noise, or the like is measured.

Then, the system control unit 421 individually adjusts, using the control signal, the delay time of each of the delay circuits 510, 223, and 224 a predetermined number of times. As described above, since the MIPI C-PHY standard adopts the clock-embedded method, the reception side can perform normal processing synchronized with the clock signal, regardless of how a difference in delay time (in other words, a phase difference) between lanes is altered.

Then, the system control unit 421 determines the combination of delay times that minimizes the measured value such as wireless sensitivity or noise level, and causes the delay configuration circuit 222 to set the delay times as a final configuration value. The delay configuration circuit 222 stores data indicating the configuration value into an internal register or the like. After the delay time configuration, the electronic device 100 exits the test mode and transitions to the normal mode. In the normal mode, the delay configuration circuit 222 delays signals using the stored data.

Note that the system control unit 421 adjusts the delay times to minimize the measured value such as wireless sensitivity, but the adjustment is not limited to this control. For example, the system control unit 421 can determine whether or not the measured value is less than or equal to a predetermined tolerance value each time the delay time adjustment is performed, and can set the delay times when the measured value becomes less than or equal to the tolerance value.

As described above, the system control unit 421 can control, by adjusting the delay time of each lane, the directivity of electromagnetic waves radiated from the three lanes on the basis of a principle similar to that of a phased array antenna. Furthermore, the system control unit 421 controls the directivity on the basis of the parameter (such as wireless sensitivity) indicating the reception performance of the antenna 120, so that it is possible to suppress electromagnetic interference affecting the antenna 120. Note that the system control unit 421 is an example of the control unit recited in the claims.

The delay time adjustment described above is performed at, for example, a factory shipment stage. Furthermore, the delay time adjustment can be performed at a predetermined timing such as when the electronic device 100 is powered on or when communication starts after the factory shipment.

The receiver circuit 422 receives a differential data signal through Lane 0 (transmission line 320) and supplies the differential data signal to the synchronization circuit 426. The synchronization circuit 426 performs clock data recovery to extract the embedded clock signal from the data signal, and supplies the data signal to the data processing unit 429 in synchronization with the clock signal. The receiver circuit 423 receives a differential data signal through Lane 1 (transmission line 330) and supplies the differential data signal to the synchronization circuit 427. The synchronization circuit 427 performs clock data recovery and supplies the data signal to the data processing unit 429. The receiver circuit 424 receives a differential data signal through Lane 2 (transmission line 340) and supplies the differential data signal to the synchronization circuit 428. The synchronization circuit 428 performs clock data recovery and supplies the data signal to the data processing unit 429.

The communication circuit 425 exchanges analog electric signals with the antenna 120. The communication circuit 425 performs analog to digital (AD) conversion, demodulation processing, and the like on the electric signal received from the antenna 120, and supplies the resultant data to the system control unit 421 as received data. Furthermore, the communication circuit 425 performs modulation processing, digital-to-analog (DA) conversion, and the like on data to be transmitted, and supplies the resultant analog electric signal to the antenna 120.

The data processing unit 429 performs various types of processing (image processing and the like) on the data signal received from each of the synchronization circuits 426, 427, and 428.

Note that, in the drawing, the SoC 420 adjusts the delay times on the basis of the wireless sensitivity and antenna coupling noise of the antenna 120, but this processing can also be performed by the sensor chip 220. In this case, it is only required that the sensor chip 220 be equipped with a system control unit, and control information indicating the measured value such as wireless sensitivity be transmitted from the SoC 420 to the system control unit of the sensor chip 220.

Furthermore, in the drawing, the number of lanes is three, but is not limited to three, and may be two or four.

### [Configuration Example of Drive Unit]

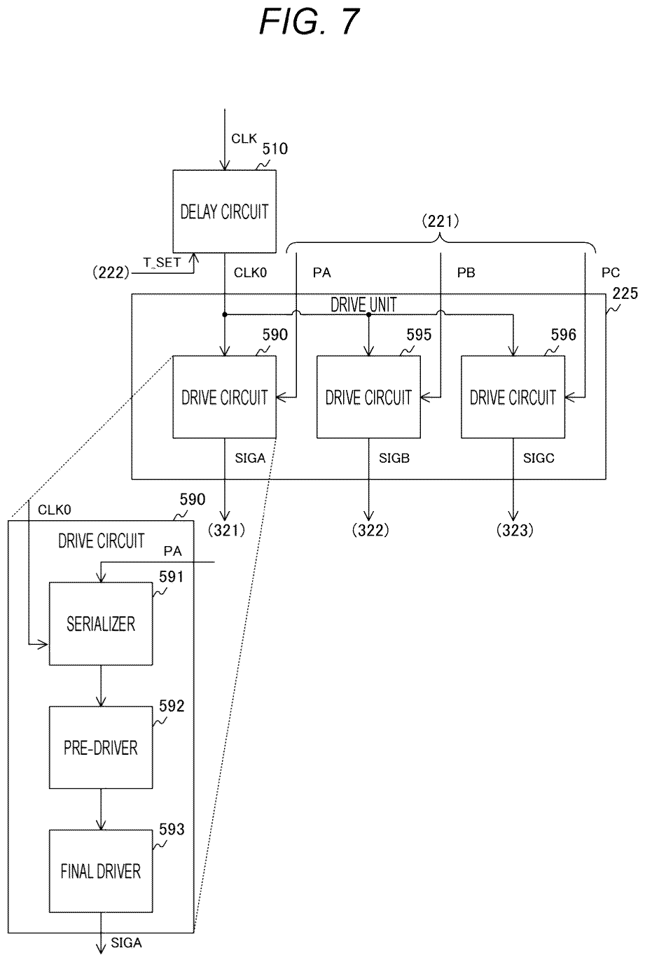

FIG. 7 is a block diagram illustrating a configuration example of the drive unit 225 according to the first embodiment of the present technology. The drive unit 225 includes drive circuits 590, 595, and 596. The drive circuit 590 includes a serializer 591, a pre-driver 592, and a final driver 593.

The serializer 591 converts parallel data PA received from the data generation unit 221 into serial data in synchronization with the clock signal CLK0 received from the delay circuit 510. The serializer 591 supplies the serial data to the pre-driver 592. The pre-driver 592 generates an output signal SIGA on the basis of the serial data and supplies the output signal SIGA to the final driver 593. The final driver 593 outputs the output signal SIGA to the signal line 321 Lane 0 (transmission line 320).

The drive circuits 595 and 596 are similar in configuration to the drive circuit 590. The drive circuit 595 performs parallel-serial conversion in synchronization with the clock signal CLK0 and outputs an output signal SIGB to the signal line 322. The drive circuit 596 performs parallel-serial conversion in synchronization with the clock signal CLK0 and outputs an output signal SIGC to the signal line 323.

Note that, with one delay circuit installed for each lane, it is also possible to control the delay circuit of each lane independently. Furthermore, in the drawing, the delay circuit 510 delays the input clock of the serializer 591, but is not limited to this configuration as long as the output of the drive circuit 590 can be delayed. For example, the delay circuit 510 can also delay the output of the serializer 591 or delay the output of the pre-driver 592.

### [Configuration Example of Delay Circuit]

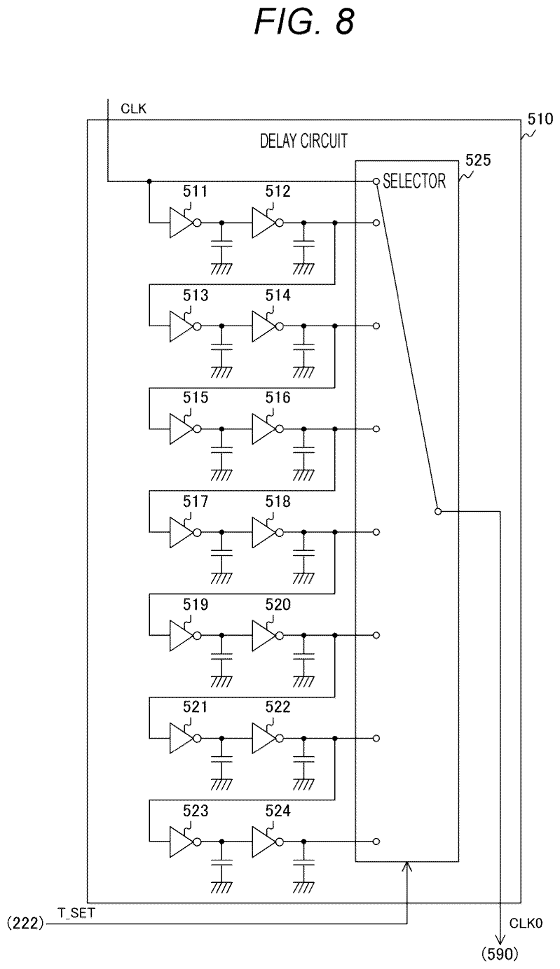

FIG. 8 is a circuit diagram illustrating a configuration example of the delay circuit 510 according to the first embodiment of the present technology. The delay circuit 510 includes a multi-stage delay elements such as inverters 511 to 524 and a selector 525. Note that buffers can also be placed as delay elements instead of the inverters.

The inverters 511 to 524 generate a plurality of delay signals with different delay times. For example, each of the inverters 512, 514, 516, 518, 520, 522, and 524 in the even-numbered stages supplies seven delay signals with different delay times to the selector 525.

Note that buffers can also be placed instead of the inverters. Furthermore, the number of delay element stages is not limited to 14 as long as it is at least one stage. Furthermore, the inverters 511 to 524 are examples of the delay element recited in claims.

The selector 525 selects either the clock signal CLK or one of the seven delay signals in accordance with a control signal T_SET received from the delay configuration circuit 222. The selector 525 supplies the selected signal to the drive circuit 590 as the clock signal CLK0.

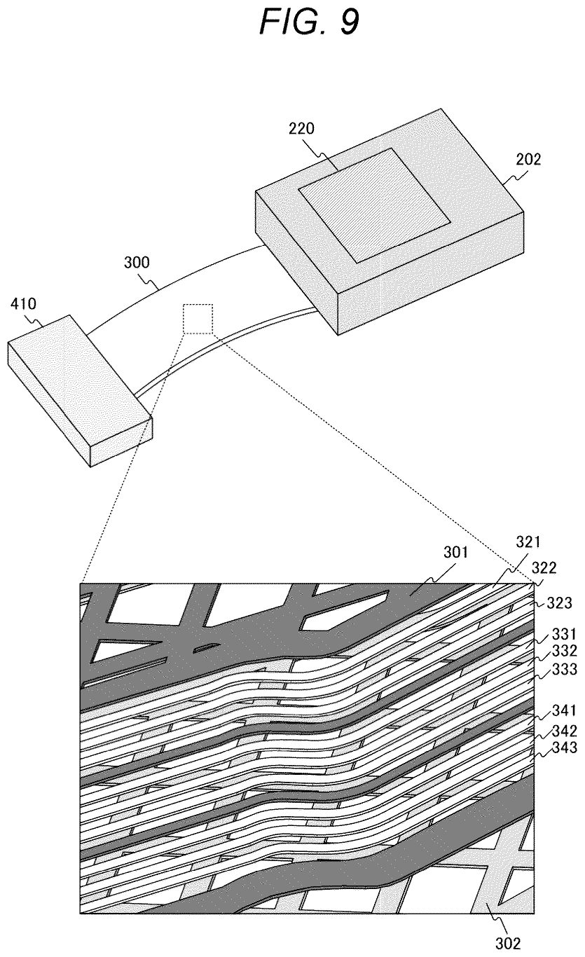

FIG. 9 is an example of an enlarged view of the FPC cable 300 according to the first embodiment of the present technology. As illustrated in the drawing, in the FPC cable 300, a ground line 301, the signal lines 321 to 323 corresponding to Lane 0, the signal lines 331 to 333 corresponding to Lane 1, and the signal lines 341 to 343 corresponding to Lane 2 are laid above a ground line 302.

Next, a result of analysis, through simulation, on changes in directivity caused by the delay time adjustment for each lane will be described. The simulation model uses the same physical property values (conductivity, permittivity, loss tangent, and the like) as those of metals, insulating films, and the like used in the device. Furthermore, regarding the chips and the cables, values representing their actual dimensions are used.

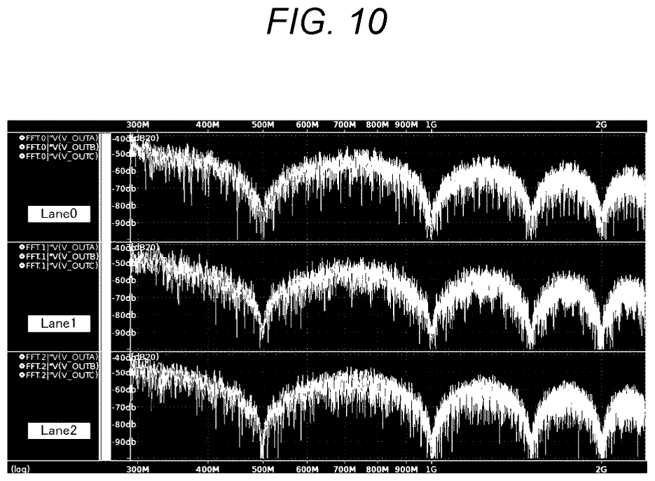

FIG. 10 is a graph showing an example of frequency characteristics of each lane in the initial state according to the first embodiment of the present technology. In the initial state, it is assumed that the delay time is set to “0” for all the three lanes. In the drawing, the vertical axis represents the levels of the output signals SIGA, SIGB, and SIGC, and the horizontal axis represents the frequency. The signal operation waveform for each lane was obtained and converted into the frequency spectrum shown in the drawing, and used as input data for the simulation model for electrolytic analysis.

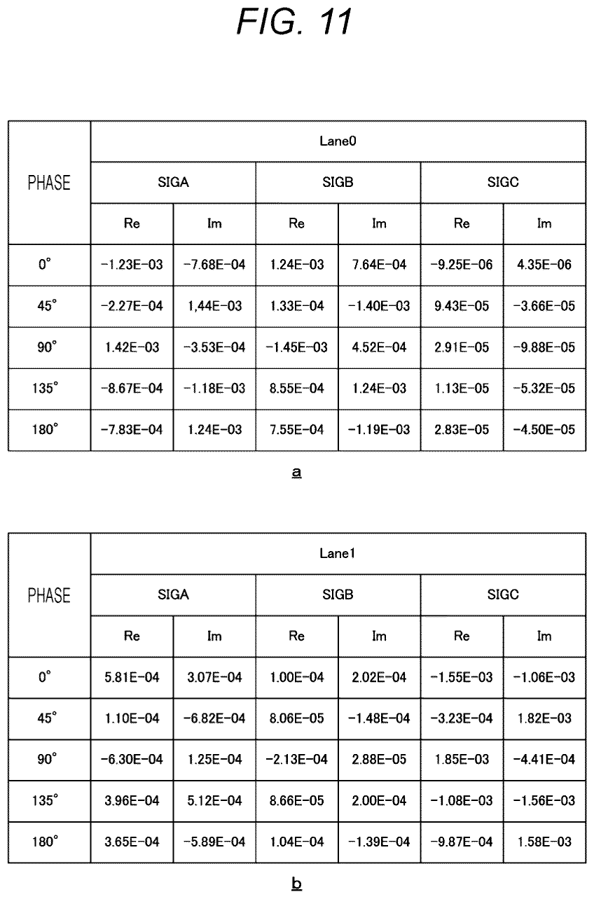

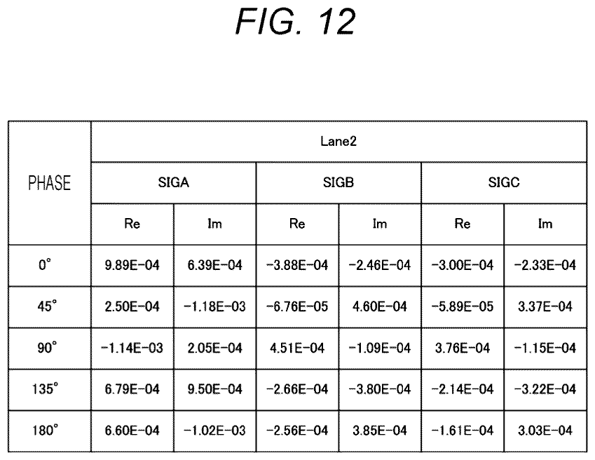

Hereinafter, the transition timing of the differential signal after delay is defined as a phase within the period of the clock signal embedded in the differential signal before delay. The frequency spectrum for each lane when the delay time adjustment is performed is obtained through simulation, and is shown in FIGS. 11 and 12.

FIG. 11 is a diagram showing an example of the frequency spectrum of each of Lanes 0 and 1 according to the first embodiment of the present technology. With the real part denoted as Re and the imaginary part denoted as Im, the waveform magnitude denoted as Ad is expressed by, for example, the following equation.

$$Ad = {( {Re}^{2} + {IM}^{2} )}^{1 / 2}$$

Furthermore, the phase θd is expressed by, for example, the following equation.

$$θ d = {tan}^{- 1} ( IM / Re )$$

a of the drawing shows Re and IM when the phases of the output signals SIGA, SIGB, and SIGC in Lane 0 are 30 adjusted to 0°, 450, 900, 135°, and 180°, respectively.

b of the drawing shows Re and IM when the phases of the output signals SIGA, SIGB, and SIGC in Lane 1 are adjusted to 00, 450, 900, 135°, and 180°, respectively.

FIG. 12 shows Re and IM when the phases of the output signals SIGA, SIGB, and SIGC in Lane 2 are adjusted to 0°, 450, 90, 135°, and 180, respectively.

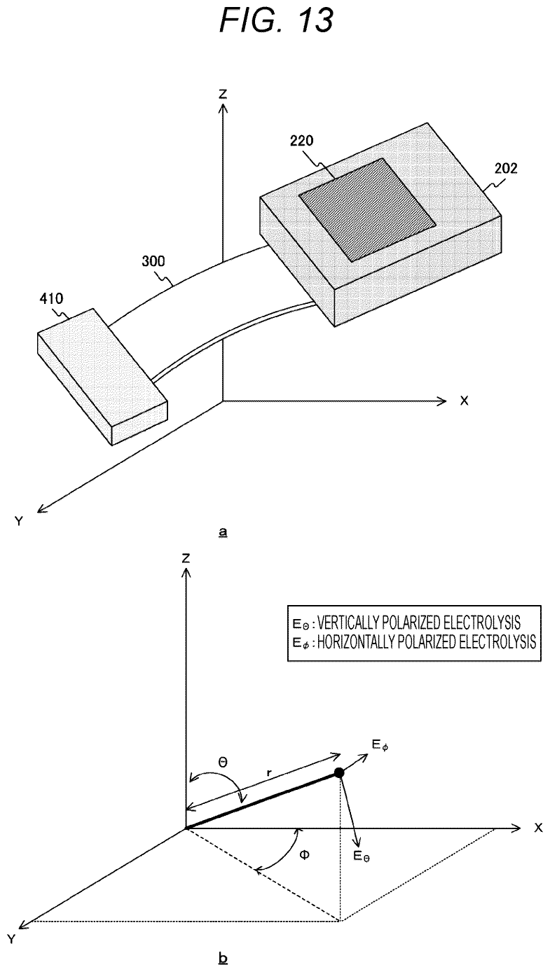

FIG. 13 is a diagram illustrating an example of coordinate axes and radiated electric field according to the first embodiment of the present technology. a of the drawing illustrates the coordinate axes (X-axis, Y-axis, and Z-axis) of the simulation model for electromagnetic field analysis. b of the drawing shows an example of the radiated electric field at an observation point located at a distance of r from the origin of the coordinate axes. An angle formed by a line segment extending from the origin to the observation point and the Z axis is denoted as θ. An angle formed between a line segment obtained by projecting the line segment extending from the origin to the observation point onto the X-Y plane and the X axis is denoted as φ. At the observation point, the radiated electric field oscillating in the θ direction is defined as a vertically polarized electric field E_{θ}, and the radiated electric field oscillating in the φ direction is defined as a horizontally polarized electric field E_{φ}.

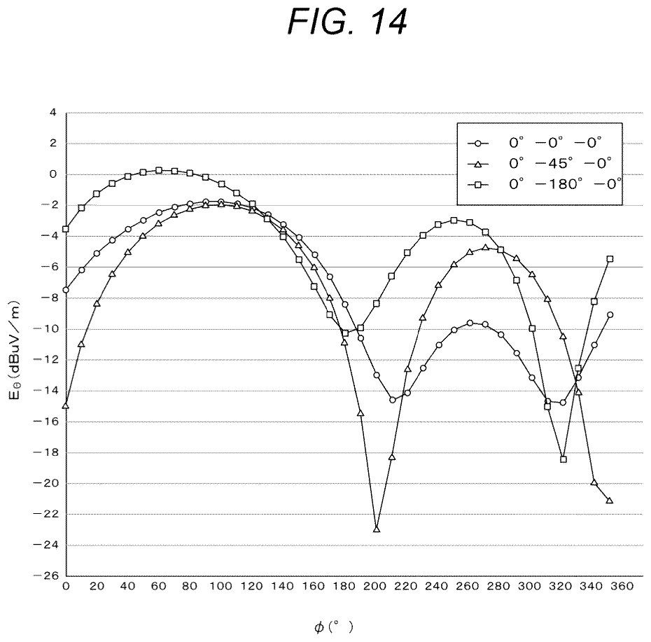

Then, the radio frequency was sequentially set to 750, 1250, and 1750 megahertz (MHz), and the combinations of the phases of Lanes 0, 1, and 2 were modified a plurality of times for each radio frequency. For each combination, θ was fixed at 900, and the relationship between 9 and the vertically polarized electric field E_{θ}, and the relationship between φ and the horizontally polarized electric field E_{φ} were obtained through simulation. Describing the radiation characteristics of all the combinations would result in an extensive amount of information, so that only some of them are shown in FIGS. 14, 15, and 16.

FIG. 14 is a diagram showing an example of the radiation characteristics of electromagnetic waves when the radio frequency is 750 megahertz (MHz). In the drawing, the horizontal axis represents 9, and the vertical axis represents the vertically polarized electric field E_{θ}. Furthermore, the white circles represent plots in a case where the phases of Lanes 0, 1, and 2 are all set to 0°. The triangles represent plots in a case where the phases of Lanes 0, 1, and 2 are set to 0°, 45°, and 0°, respectively. The squares represent plots in a case where the phases of Lanes 0, 1, and 2 are set to 0°, 180°, and 0°, respectively.

As shown in the drawing, shifting the phase of each lane results in significant changes in the radiation characteristics. With the orientation of the antenna set to 210, E_{θ} for the direction becomes the smallest in a case where the phases are set to 0°, 45°, and 0°.

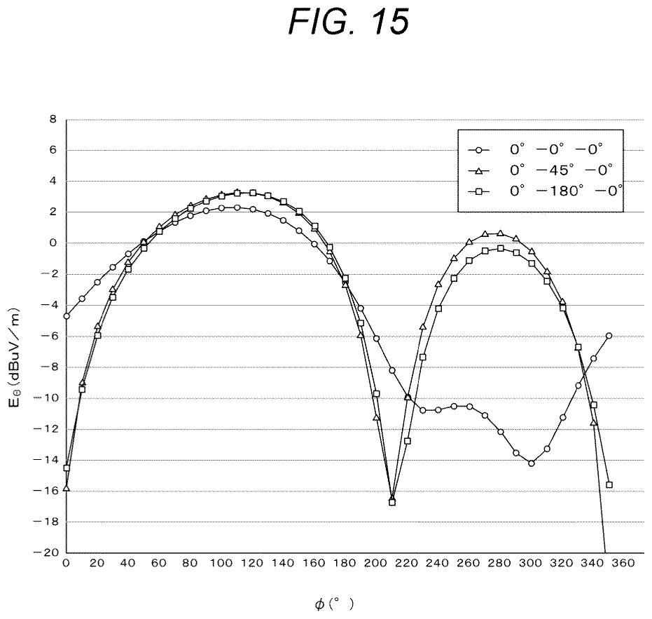

FIG. 15 is a diagram showing an example of the radiation characteristics of electromagnetic waves when the radio frequency is 1250 megahertz (MHz).

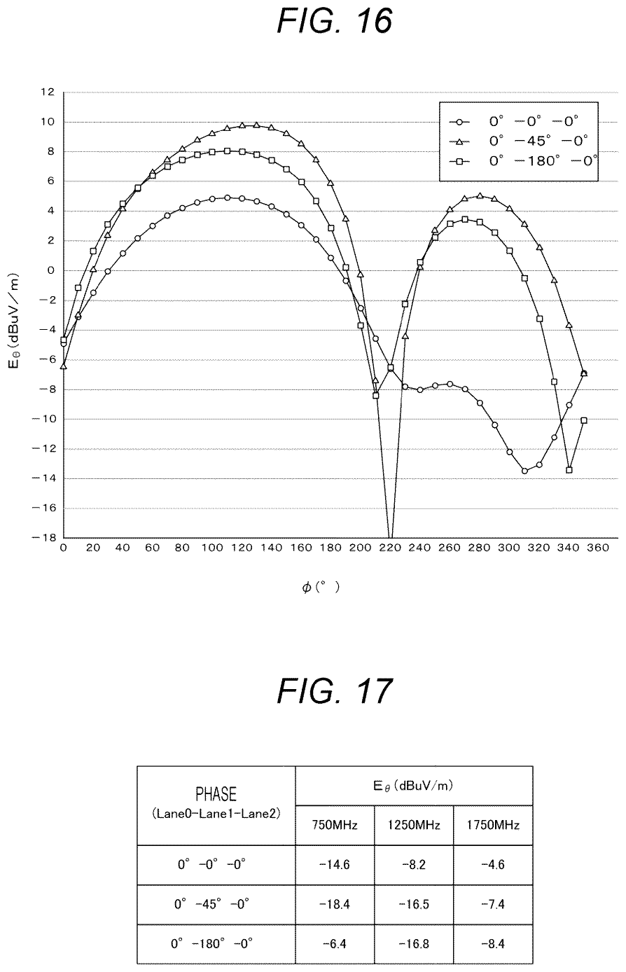

FIG. 16 is a diagram showing an example of the radiation characteristics of electromagnetic waves when the radio frequency is 1750 megahertz (MHz).

As shown in FIGS. 14 to 16, when the radio frequency changes, the radiation characteristics of electromagnetic waves from each lane also change. In the graphs shown in FIGS. 14 to 16, the vertically polarized electric field E_{θ} with θ set to, for example, 90 degrees and Φ set equal to the orientation of the antenna (for example, 210°) is summarized in FIG. 17.

As shown in FIG. 17, in a case where the radio frequency is 750 megahertz (MHz), it is possible to minimize the vertically polarized electric field E_{θ} by setting the phases of Lanes 0, 1, and 2 to 00, 450, and 0°, respectively, among the three combinations.

Furthermore, in a case where the radio frequency is 1250 or 1750 megahertz (MHz), it is possible to minimize the vertically polarized electric field E_{θ} by setting the phases of Lanes 0, 1, and 2 to 0°, 180°, and 0°, respectively, among the three combinations.

Furthermore, when the vertically polarized electric field E_{θ} at each radio frequency is comprehensively considered, the combination of 0°, 45°, and 0° is most suitable.

Note that, although there is no value for the horizontally polarized electric field E, in the drawing, the electronic device 100 can also adjust the phase to reduce the horizontally polarized electric field E_{φ}. Furthermore, the electronic device 100 can also adjust the phase to reduce both the vertically polarized electric field E_{θ} and the horizontally polarized electric field E_{φ}.

### [Example of Operation of Electronic Device]

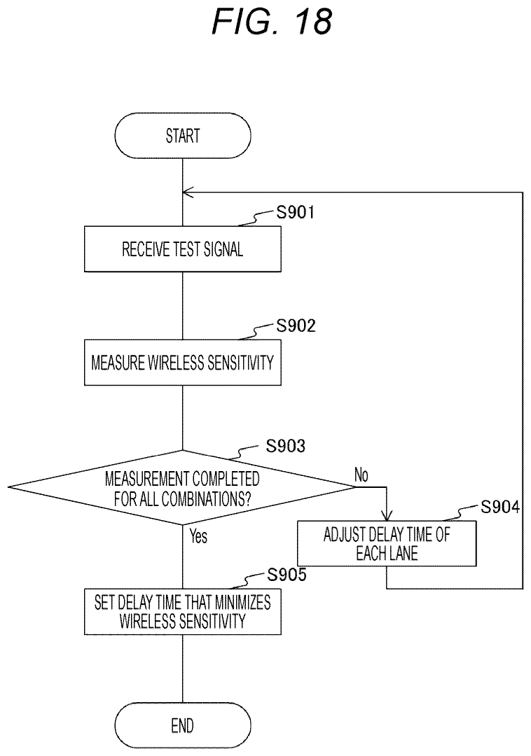

FIG. 18 is a flowchart illustrating an example of the operation of the electronic device 100 according to the first embodiment of the present technology. This operation starts when the test mode for delay time adjustment is enabled, for example. Note that the flow illustrated in the drawing can also start when the normal mode is enabled.

The electronic device 100 receives the test signal (step S901). Then, the electronic device 100 measures the wireless sensitivity of the antenna 120 (step S902). Note that, as described above, the electronic device 100 can also measure the antenna coupling noise instead of the wireless sensitivity.

The electronic device 100 determines whether or not the measurement of the wireless sensitivity has been completed for all the combinations of the delay times of each lane (step S903). In a case where the measurement has not been completed for all the combinations (step S903: No), the electronic device 100 adjusts the delay time of each lane (step S904), and repeats step S901 and the subsequent steps.

On the other hand, in a case where the measurement has been completed for all the combinations (step S903: Yes), the electronic device 100 sets the delay time of each lane that minimizes the wireless sensitivity as a final value (step S905), and completes the operation in the test mode.

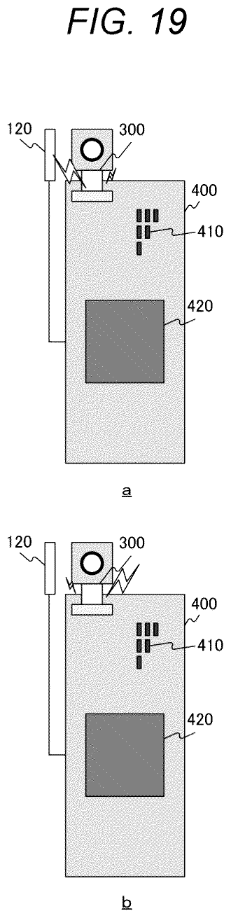

FIG. 19 is a diagram illustrating an example of the directivity of electromagnetic waves before and after the delay time adjustment according to the first embodiment of the present technology. a of the drawing illustrates an example of the directivity of electromagnetic waves in the initial state in which all the lanes in the FPC cable 300 have a delay time of 0 nanoseconds (in other words, a phase of 0°).

In a case where the antenna 120 is located near the left side of the FPC cable 300 as illustrated in a of the drawing, the stronger the electric field radiated from the FPC cable 300 in the leftward direction, the greater the coupling noise of the antenna 120 becomes.

However, as illustrated in b of the drawing, the SoC 420 can control the directivity of the radiated electric field toward the right side to suppress the degradation of the wireless sensitivity. Furthermore, as shown in FIGS. 14 to 16, the radiation characteristics may vary with frequency, or the frequency band used by the electronic device 100 may differ in a manner that depends on a target market country. By performing the processing illustrated in FIG. 19 in a state where the test signal (alternatively, a signal transmitted in the normal mode) has been received at a frequency used in the target market, the optimal delay time for the frequency can be easily set.

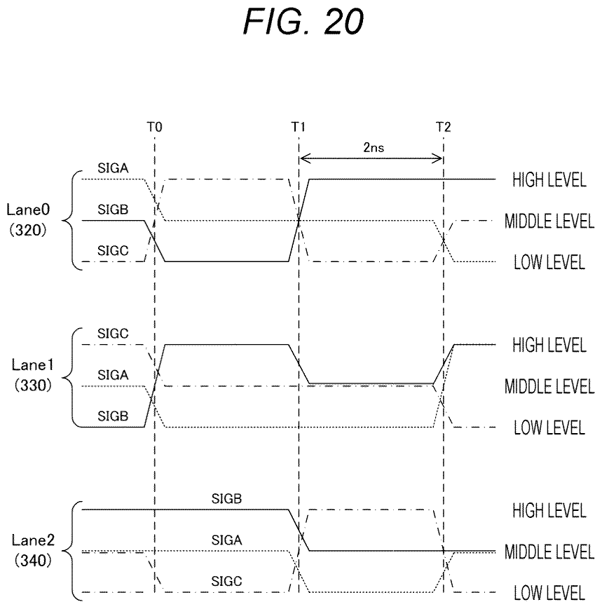

FIG. 20 is a diagram showing an example of the waveform of the differential signal in the initial state according to the first embodiment of the present technology. Through each of Lanes 0, 1, 2, the output signals SIGA, SIGB and SIGC are transmitted. A dotted line represents the waveform of the output signal SIGA, a solid line represents the waveform of the output signal SIGB, and a long dashed short dashed line represents the waveform of the output signal SIGC.

The levels of these signals transition to high-level, middle-level, or low-level in a manner that depends on the value of data to be transmitted. Furthermore, three types of differential signals including a differential signal formed by the output signals SIGA and SIGB, a differential signal formed by the output signals SIGB and SIGC, and a differential signal formed by the output signals SIGC and SIGA are transmitted.

Furthermore, each of the output signals transitions in synchronization with the embedded clock signal. For example, the levels of the output signals SIGA, SIGB, and SIGC transition at timings T0, T1, and T2. The intervals between these transition timings corresponds to the period of the clock signal. If the data rate is 500 million symbols per second (Msps), its period is 2 nanoseconds (ns). In the drawing, the delay times of Lanes 0, 1, and 2 are identical in the initial state, so that the transition timings of the lanes are identical.

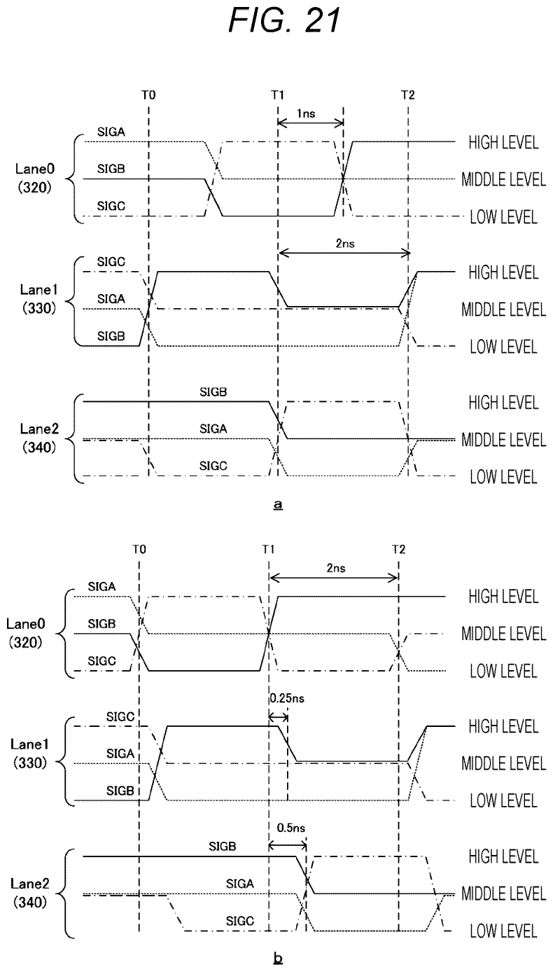

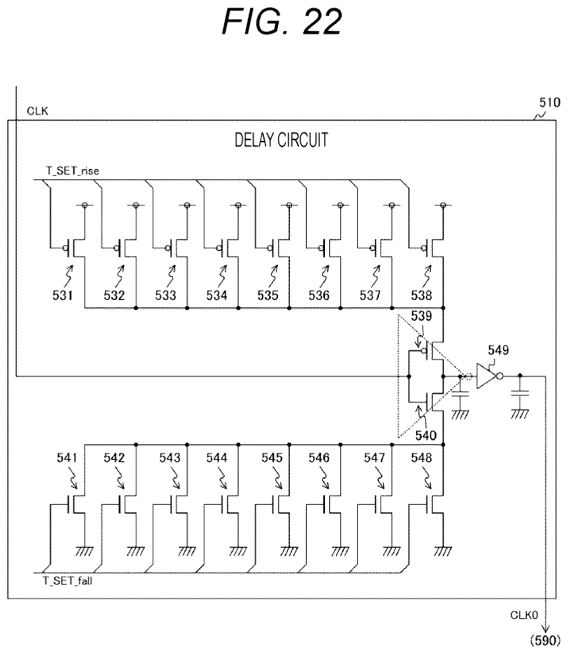

FIG. 21 is a diagram showing an example of the waveform of the differential signal after the delay time adjustment according to the first embodiment of the present technology. a of the drawing shows a waveform in a case where the delay times of Lanes 0, 1, and 2 are set to 1, 0, and 0 nanoseconds (ns), respectively. In this case, the phases of Lanes 0, 1, and 2 are 180°, 0°, and 0°, respectively.

Furthermore, b of the drawing shows a waveform in a case where the delay times of Lanes 0, 1, and 2 are set to 0, 0.25, and 0.5 nanoseconds (ns), respectively. Since the period is 2 nanoseconds (ns), the phases of Lanes 0, 1, and 2 are 0°, 45°, and 90°, respectively.

As shown in the drawing, by intentionally introducing a phase difference for each lane, it is possible to change the propagation direction of the composite electromagnetic field radiated from all the lanes at a specific frequency. Furthermore, the composite electric fields radiated from each lane also have a mutual canceling effect at a specific frequency, so that it is also possible to achieve the effect of reducing the value of the electric field itself. For example, by setting the phases of Lanes 0, 1, and 2 to 0°, 180°, and 180°, respectively, at a specific frequency, it is possible to achieve the cancellation effect. This means that, in a case where the phase of Lane 0 is set to 0° and the electric field at a specific point is approximately 1, when the phase of Lane 1 is set to 180° and the electric field at the specific point is approximately 0.5, and the phase of Lane 2 is set to 180° and the electric field at the specific point is approximately 0.5, the composite electric field at the specific point can be brought close to zero.

As described above, according to the first embodiment of the present technology, the system control unit 421 controls the directivity of the electromagnetic waves radiated from the three lanes on the basis of the reception performance of the antenna 120, so that it is possible to suppress electromagnetic interference to enhance wireless sensitivity.

### 2. Second Embodiment

In the first embodiment described above, the delay time adjustment is performed by the delay circuit 510 equipped with the multi-stage delay elements and the selector 525, but the present technology is not limited to this circuit configuration. An electronic device 100 according to the second embodiment is different from that of the first embodiment in that a circuit having a plurality of transistors connected in parallel on the power supply side and the ground side is used as the delay circuit 510.

FIG. 22 is a circuit diagram illustrating a configuration example of a delay circuit 510 according to the second embodiment of the present technology. The delay circuit 510 of the second embodiment includes p-channel metal oxide semiconductor (pMOS) transistors 531 to 539, n-channel MOS (nMOS) transistors 540 to 548, and an inverter 549.

The pMOS transistor 539 and the nMOS transistor 540 are connected in series between the input terminal of the delay circuit 510 and the input terminal of the inverter 549 with the pMOS transistor 539 placed on the power supply side.

The pMOS transistor 539 and the nMOS transistor 540 output a signal obtained by inverting and delaying the clock signal CLK to the inverter 549. The inverter 549 inverts the input signal and outputs the inverted signal to the drive circuit 590 as a clock signal CLK0. Note that the pMOS transistor 539 and the nMOS transistor 540 are examples of the logic circuit recited in the claims.

Furthermore, the pMOS transistors 531 to 538 are connected in parallel between the source of the pMOS transistor 539 and the ground node. The n-th bit (n is an integer of 0 to 7) of an 8-bit control signal T_SET_rise received from the delay configuration circuit 222 is input into the gate of the n-th pMOS transistor.

Furthermore, the nMOS transistors 541 to 548 are connected in parallel between the source of the nMOS transistor 540 and the power supply node. The n-th bit of an 8-bit control signal T_SET_fall received from the delay configuration circuit 222 is input into the gate of the n-th nMOS transistor.

The system control unit 421 can adjust the rise time and fall time of the clock signal in accordance with the control signals T_SET_rise and T_SET_fall using the delay configuration circuit 222. In the drawing, at least one nMOS transistor and at least one pMOS transistor are controlled to be in the ON state. The fewer the number of transistors in the ON state, the smaller the total gate width (in other words, the transistor size) of the parallel-connected MOS transistors, resulting in a longer delay time.

Note that eight pMOS transistors and eight nMOS transistors are connected in parallel, the number of MOS transistors connected in parallel is not limited to eight as long as it is two or more.

As described above, according to the second embodiment of the present technology, the system control unit 421 controls ON/OFF of the pMOS transistors and the nMOS transistors connected in parallel, so that it is possible to adjust the delay time according to their sizes (total gate width).

### 3. Third Embodiment

In the first embodiment described above, the delay time adjustment is performed by the delay circuit 510 equipped with the multi-stage delay elements and the selector 525, but the present technology is not limited to this circuit configuration. An electronic device 100 according to the third embodiment is different from that of the first embodiment in that the bias voltage of the transistors in the delay circuit 510 is controlled.

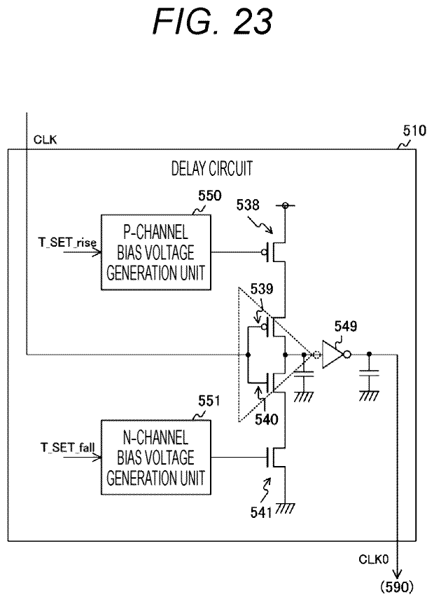

FIG. 23 is a circuit diagram illustrating a configuration example of a delay circuit 510 according to the third embodiment of the present technology. The delay circuit 510 of the third embodiment includes pMOS transistors 538 and 539, nMOS transistors 540 and 541, an inverter 549, a P-channel bias voltage generation unit 550, and an N-channel bias voltage generation unit 551.

The pMOS transistor 539 and the nMOS transistor 540 are connected in series between the input terminal of the delay circuit 510 and the input terminal of the inverter 549 with the pMOS transistor 539 placed on the power supply side. The inverter 549 inverts the input signal and outputs the inverted signal to the drive circuit 590 as a clock signal CLK0.

The pMOS transistor 538 is inserted between the source of the pMOS transistor 539 and the power supply node. The nMOS transistor 541 is inserted between the source of the nMOS transistor 540 and the ground node.

The P-channel bias voltage generation unit 550 generates a P-channel bias voltage in accordance with the control signal T_SET_rise received from the delay configuration circuit 222, and supplies the P-channel bias voltage to the gate of the pMOS transistor 538. The N-channel bias voltage generation unit 551 generates an N-channel bias voltage in accordance with the control signal T_SET_fall received from the delay configuration circuit 222, and supplies the N-channel bias voltage to the gate of the nMOS transistor 541. It is assumed that the P-channel bias voltage and the N-channel bias voltage can be switched in multiple levels, that is, two or more levels.

Note that the P-channel bias voltage generation unit 550 and the N-channel bias voltage generation unit 551 are examples of the first and second bias voltage generation units recited in the claims.

The system control unit 421 can control the bias voltages in accordance with the control signals T_SET_rise and T_SET_fall using the delay configuration circuit 222 to adjust the rise time and fall time of the clock signal. The higher the P-channel bias voltage or the lower the N-channel bias voltage, the longer the delay time.

As described above, according to the third embodiment of the present technology, the system control unit 421 controls the bias voltages of the pMOS transistor 538 and the nMOS transistor 541, so that it is possible to adjust the delay time according to the bias voltages.

### 4. Fourth Embodiment

In the first embodiment described above, the MIPI C-PHY standard is used for transmission of signals between the sensor chip 220 and the SoC 420, but the present technology is not limited to this standard. An electronic device 100 of the fourth embodiment is different from that of the first embodiment in that the MIPI D-PHY standard is used.

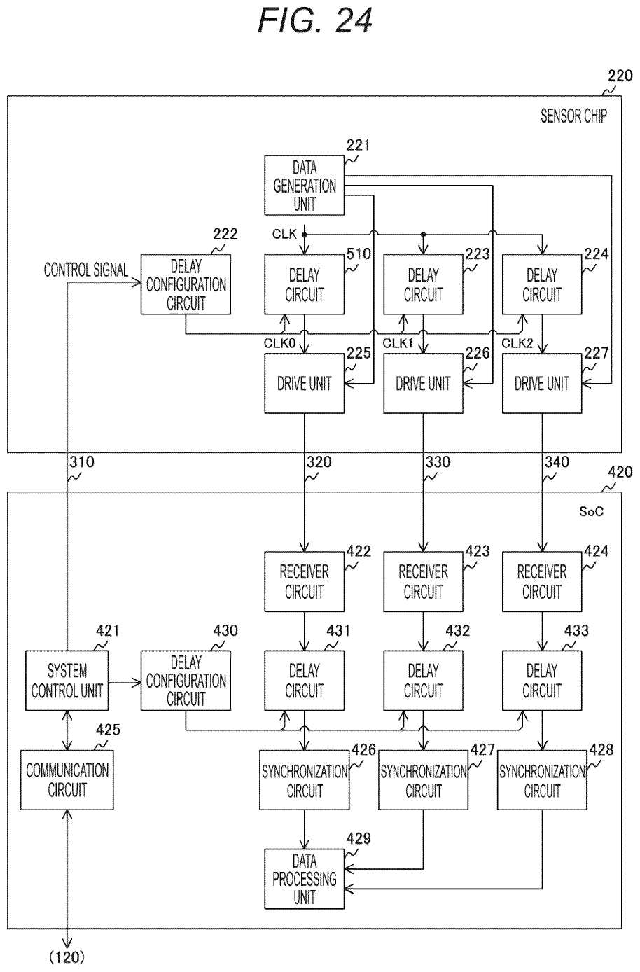

FIG. 24 is a block diagram illustrating a configuration example of a sensor chip 220 and a SoC 420 according to the fourth embodiment of the present technology. As the communication standard applied to the transmission lines 320, 330, and 340 of the fourth embodiment, the MIPI D-PHY standard is used. Under the MIPI D-PHY standard, the clock-embedded method is not used, and the data signal and the clock signal are transmitted through separate lanes. For example, the transmission lines 320, 330, and 340 are used as data lanes to transmit the data signal, and the clock signal is transmitted through a clock lane (not illustrated) different from the data lanes. As described above, the clock signal is transmitted through the clock lane, which eliminates the need for performing clock data recovery on the reception side.

In a case where the clock-embedded method is not used, when the phase is shifted on the transmission side, it is necessary to reset the phase on the reception side. Therefore, in the fourth embodiment, the SoC 420 is further equipped with a delay configuration circuit 430 and delay circuits 431, 432, and 433.

The delay circuit 431 delays a signal transmitted through Lane 0 (transmission line 320) and supplies the resultant signal to the synchronization circuit 426. The delay circuit 432 delays a signal transmitted through Lane 1 (transmission line 330) and supplies the resultant signal to the synchronization circuit 427. The delay circuit 433 delays a signal transmitted through Lane 2 (transmission line 340) and supplies the resultant signal to the synchronization circuit 428.

The delay configuration circuit 430 sets the delay time of each of the delay circuits 431, 432, and 433 under the control of the system control unit 421.

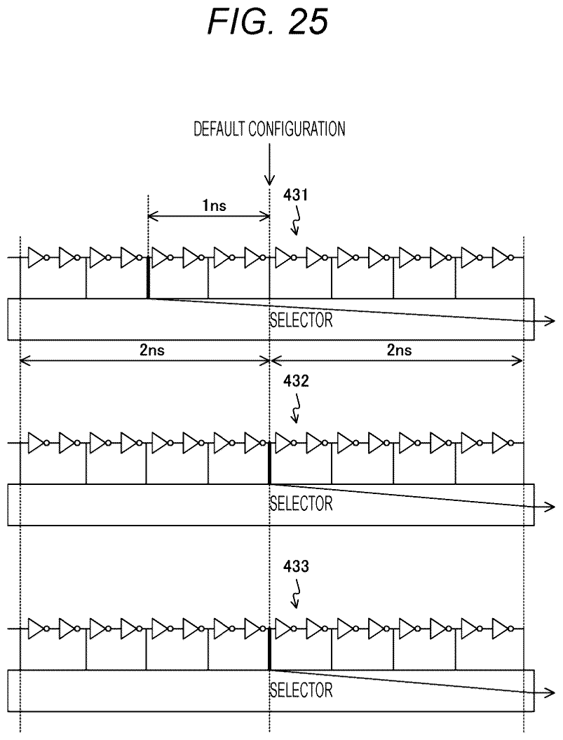

FIG. 25 is a diagram illustrating an example of the delay time on the reception side according to the fourth embodiment of the present technology. It is assumed that each of the delay circuits 431, 432, and 433 on the reception side is equipped with multi-stage delay elements and a selector, similar to the transmission side. Note that the delay circuits 431, 432, and 433 are examples of the reception-side delay circuit recited in the claims.

Furthermore, the number of delay elements installed in the transmission-side delay circuit and the number of delay elements installed in the reception-side delay circuit may be different. In a case where the individual delay times of the delay elements are identical, the number of delay element stages on the reception side is preferably greater than that on the transmission side.

It is assumed that the period of the clock signal is 2 nanoseconds (ns), and in the default configuration, the delay time of each of the delay circuits 431, 432, and 433 is, for example, 2 nanoseconds (ns). Furthermore, it is assumed that the delay time can be controlled within a range of 0 to 4 nanoseconds (ns). This allows the phase to be adjusted within a range of −180° to +180° on the reception side.

Here, it is assumed that the system control unit 421 adjusts the delay times of Lanes 0, 1, and 2 on the transmission side to 1, 0, and 0 nanoseconds (ns), respectively. In this case, as illustrated in the drawing, the system control unit 421 controls the delay time of Lane 0 on the reception side to be shorter by 1 nanosecond than the default configuration (that is, 1 nanosecond) using the delay configuration circuit 430, and keeps the delay times of Lanes 1 and 2 at the default configuration. This allows the phase of Lane 0 shifted on the transmission side to be reset on the reception side. By resetting the phase, it is possible for the reception side to receive the data signal normally even in a case where the MIPI D-PHY standard is used.

Note that each of the second and third embodiments is applicable to the fourth embodiment.

As described above, according to the fourth embodiment of the present technology, the system control unit 421 controls the delay time on the reception side to reset the phase, so that it is possible for the reception side to receive the data signal normally even in a case where the clock-embedded method is not used.

### 5. Fifth Embodiment

In the fourth embodiment described above, the SoC 420 on the reception side controls the delay time, but the present technology is not limited to this configuration. An electronic device 100 of the fifth embodiment is different from that of the fourth embodiment in that the delay time adjustment is performed on both the transmission side and the reception side.

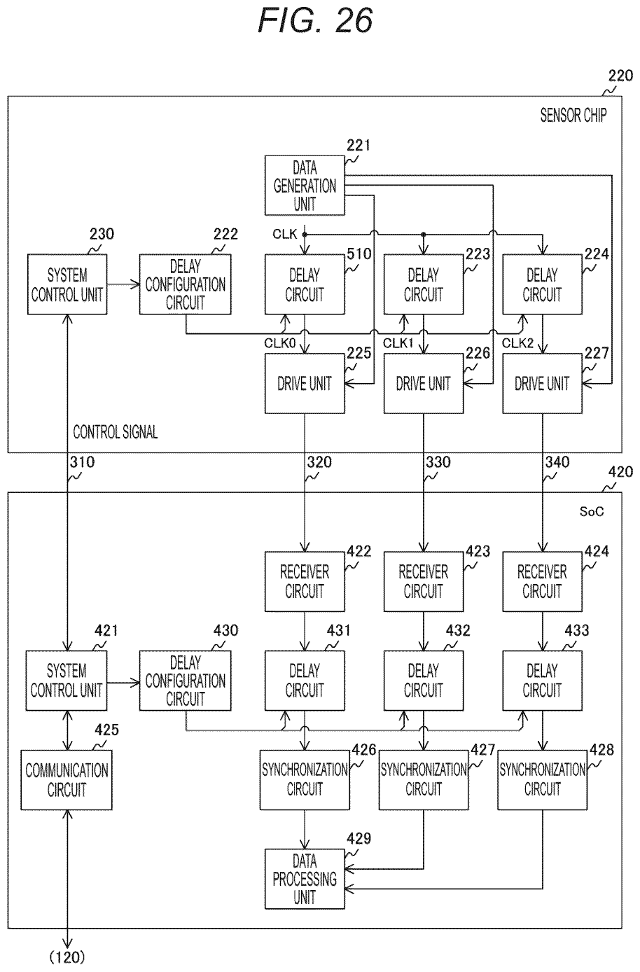

FIG. 26 is a block diagram illustrating a configuration example of a sensor chip 220 and a SoC 420 according to the fifth embodiment of the present technology. The sensor chip 220 of the fifth embodiment is different from that of the fourth embodiment in that a system control unit 230 is further included.

In the fifth embodiment, the system control unit 421 on the reception side of the data signal supplies a control signal indicating a measured value such as wireless sensitivity to the system control unit 230 on the transmission side. The system control unit 421 sets the delay time of each lane on the transmission side on the basis of the measured value.

Then, the system control unit 230 supplies a control signal related to the delay time of each lane to the system control unit 421, and the system control unit 421 sets the delay time on the reception side on the basis of the control signal.

Here, the system control unit 230 on the transmission side transmits, for example, a control signal indicating the configuration value of the delay time of each lane itself to the system control unit 421 on the reception side. Alternatively, the system control unit 230 supplies a control signal indicating the frequency of the clock signal and the phase of each lane. In this case, the system control unit 421 calculates the delay time of each lane from the received frequency and phase, and sets the value for each lane.

Note that the system control unit 230 is an example of the transmission-side control unit recited in the claims, and the system control unit 421 is an example of the reception-side control unit recited in the claims.

As illustrated in the drawing, by assigning the delay time adjustment function to the sensor chip 220, it is possible to reduce the circuit scale and design burden of the SoC 420.

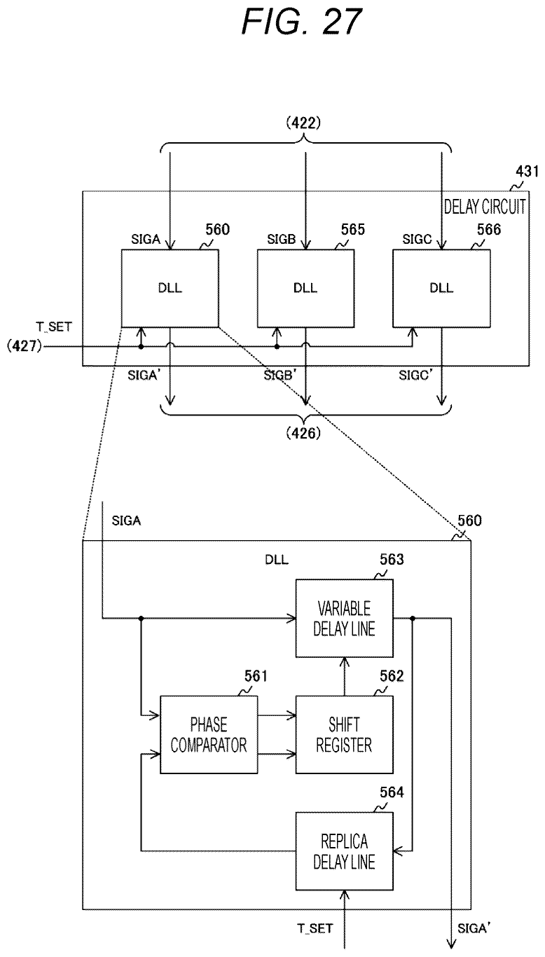

FIG. 27 is a circuit diagram illustrating a configuration example of a delay circuit 431 according to the fifth embodiment of the present technology. The delay circuit 431 includes, for example, a delay locked loop (DLL) 560, a DLL 565, and a DLL 566. These DLLs 560, 565 and 566 delay the output signals SIGA, SIGB, and SIGC and output the resultant signals as delay signals SIGA′, SIGB′, and SIGC′ to the synchronization circuit 426.

The DLL 560 includes, for example, a phase comparator 561, a shift register 562, a variable delay line 563, and a replica delay line 564. The DLLs 565 and 566 are similar in circuit configuration to the DLL 560.

The phase comparator 561 compares the phase of the input SIGA with the phase of a signal fed back from the replica delay line 564, and supplies the comparison result to the shift register 562.

The shift register 562 shifts a bit sequence on the basis of the comparison result and supplies the resultant bit sequence to the variable delay line 563. The variable delay line 563 delays SIGA, outputs the resultant signal as SIGA′, and feeds it back to the replica delay line 564. The delay time of the variable delay line 563 is controlled in accordance with the bit sequence supplied from the shift register 562.

The replica delay line 564 delays SIGA′ and supplies the resultant signal to the phase comparator 561 as a feedback signal. The delay time of the replica delay line 564 is controlled in accordance with a control signal T_SET supplied from the delay configuration circuit 430. By shortening the delay time of the replica delay line 564, it is possible to extend the delay time of the variable delay line 563 accordingly.

Note that the circuit configuration of the DLL 560 is not limited to the example illustrated in the drawing. For example, an up/down counter may be placed instead of the shift register 562. Furthermore, a charge pump and a voltage control delay line may be placed instead of the shift register 562 and the variable delay line 563.

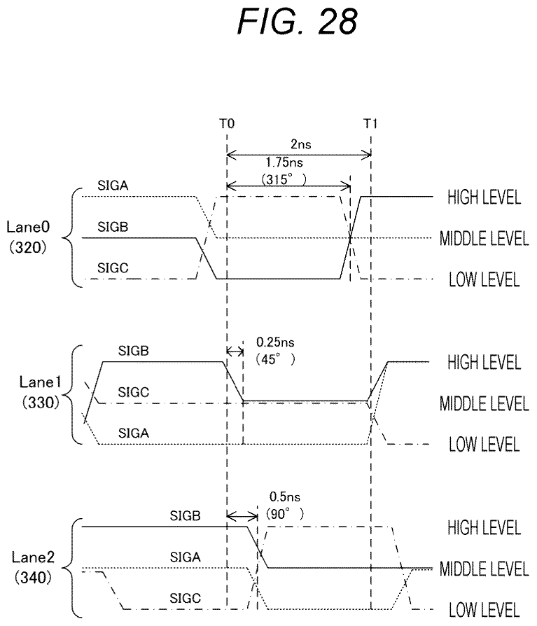

FIG. 28 is a diagram illustrating an example of the waveform of the differential signal after the delay time adjustment according to the fifth embodiment of the present technology. It is assumed that the system control unit 230 on the transmission side sets the delay times of Lanes 0, 1, and 2 to 1.75, 0.25, and 0.5 nanoseconds (ns), respectively, on the basis of wireless sensitivity and the like. Furthermore, the period of the clock signal is 2 nanoseconds (ns). The phases of Lanes 0, 1, and 2 are 315°, 45°, and 90°, respectively.

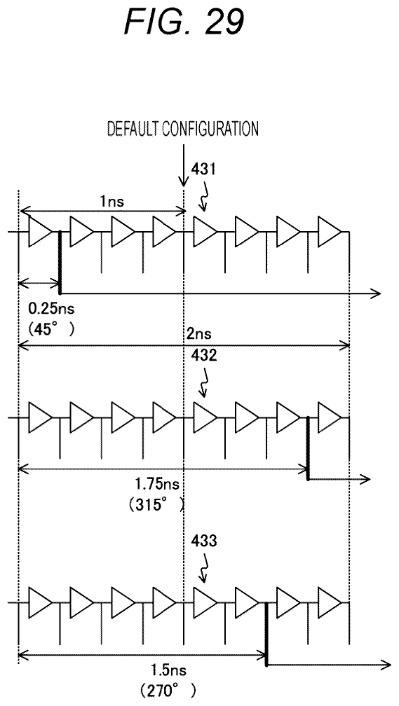

FIG. 29 is a diagram illustrating an example of the delay time of the delay circuit on the reception side according to the fifth embodiment of the present technology. The system control unit 421 on the reception side sets the delay times of the delay circuits 431, 432, and 433 corresponding to Lanes 0, 1, and 2 to 0.25, 1.75, and 1.5 nanoseconds (ns), respectively. Their respective phases are 45°, 315°, and 270°. When the phase of the transmission side and the phase of the reception side are added, the result is 360°, and the phase is reset accordingly.

Note that the second and third embodiments are applicable to the fifth embodiment.

As described above, according to the fifth embodiment of the present technology, the system control unit 230 on the transmission side adjusts the delay time, so that it is possible to reduce the circuit scale and design burden of the SoC 420.

### 6. Sixth Embodiment

In the fifth embodiment described above, the system control unit 230 on the transmission side transmits the control signal (frequency and phase) related to the delay time to the reception side, but this configuration makes it difficult for the reception side to reset the phase. For example, the actual delay time of the delay circuit may deviate from the design value due to, for example, variations in process, voltage, and temperature (PVT). Therefore, if the design value on the transmission side is applied as it is to the reception side, an error may occur in the reset phase. An electronic device 100 according to the sixth embodiment is different from that of the fifth embodiment in that the reception side determines whether or not the sign of a phase difference between the edges of two lanes has been inverted.

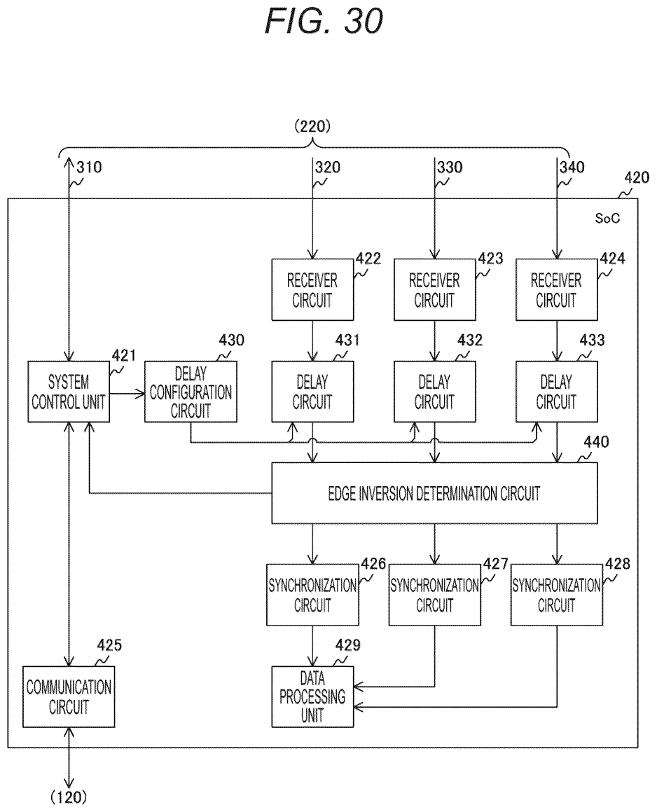

FIG. 30 is a block diagram illustrating a configuration example of a SoC 420 according to the sixth embodiment of the present technology. The SoC 420 of the sixth embodiment is different from that of the fifth embodiment in that an edge inversion determination circuit 440 is further included.

Furthermore, when setting the delay time of each lane, the system control unit 230 on the transmission side transmits a control signal indicating a magnitude relationship among the delay times of the lanes to the system control unit 421 on the reception side. For example, in a case where the delay times of Lanes 0, 1, and 2 are 0.1, 0, and 0 nanoseconds (ns), respectively, a control signal indicating that the delay time of Lane 0 is longer than the delay times of Lanes 1 and 2 and the delay times of Lanes 1 and 2 are identical is transmitted. Then, the system control unit 421 on the reception side adjusts the delay time of each lane on the basis of the control signal and the determination result received from the edge inversion determination circuit 440. Details of the delay time adjustment method will be described later.

The edge inversion determination circuit 440 determines whether or not the sign of a phase difference between the edge of a delay signal through a specific lane and the edge of a delay signal through another lane has been inverted, and transmits the determination result to the system control unit 421. In a case where there are three Lanes 0, 1, and 2, a determination result between Lane 0 and Lane 1, a determination result between Lane 1 and Lane 2, and a determination result between Lane 2 and Lane 0 are transmitted.

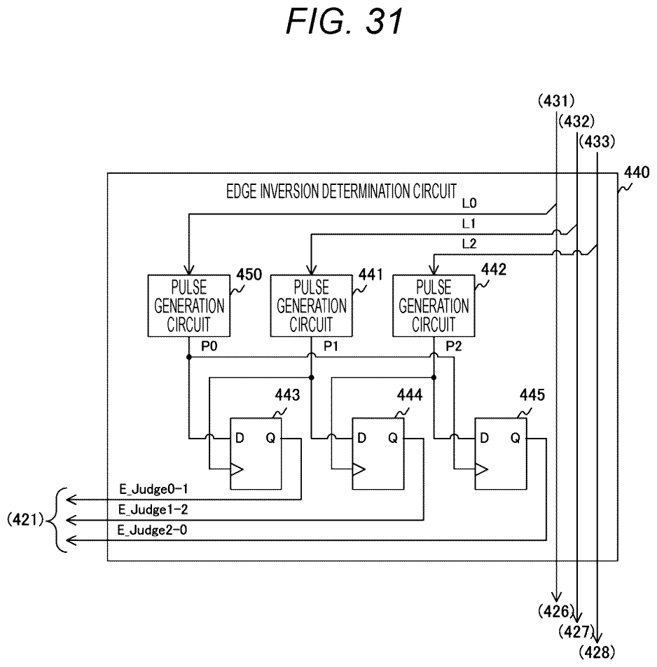

FIG. 31 is a block diagram illustrating a configuration example of the edge inversion determination circuit 440 according to the sixth embodiment of the present technology. The edge inversion determination circuit 440 includes pulse generation circuits 450, 441, and 442 and flip-flops 443, 444, and 445.

Any one of the three delay signals SIGA′, SIGB′, and SIGC′ supplied from the delay circuit 431 corresponding to Lane 0 is input into the pulse generation circuit 450 as L0.

Furthermore, the three delay signals supplied from the delay circuit 431 are input into the synchronization circuit 426. Any one of the three delay signals supplied from the delay circuit 432 corresponding to Lane 1 is input into the pulse generation circuit 441 as L1. Furthermore, the three delay signals supplied from the delay circuit 431 are input into the synchronization circuit 427. Any one of the three delay signals supplied from the delay circuit 433 corresponding to Lane 2 is input into the pulse generation circuit 442 as L2. Furthermore, the three delay signals supplied from the delay circuit 433 are input into the synchronization circuit 428.

The pulse generation circuit 450 detects a rising edge or a falling edge of the delay signal L0 and generates a one-shot pulse. This pulse signal is input as P0 into a D terminal which is the input terminal of the flip-flop 443 and a clock terminal of the flip-flop 445. Note that the pulse width of the one-shot pulse needs to be greater than or equal to the setup time and hold time of the flip-flop 443 and the like.

The pulse generation circuit 441 detects a rising edge or a falling edge of the delay signal L1 and generates a pulse signal P1. This pulse signal P1 is input into a D terminal of the flip-flop 444 and a clock terminal of the flip-flop 443.

The pulse generation circuit 442 detects a rising edge or a falling edge of the delay signal L2 and generates a pulse signal P2. This pulse signal P2 is input into a D terminal of the flip-flop 445 and a clock terminal of the flip-flop 444.

D flip-flops are used as the flip-flops 443, 444, and 445. The determination result between Lanes 0 and 1 is output from a Q terminal which is the output of the flip-flop 443 to the system control unit 421 as E_Judge0-1. The determination result between Lanes 1 and 2 is output from a Q terminal of the flip-flop 444 to the system control unit 421 as E_Judge1-2. The determination result between Lanes 2 and 0 is output from a Q terminal of the flip-flop 445 to the system control unit 421 as E_Judge2-0.

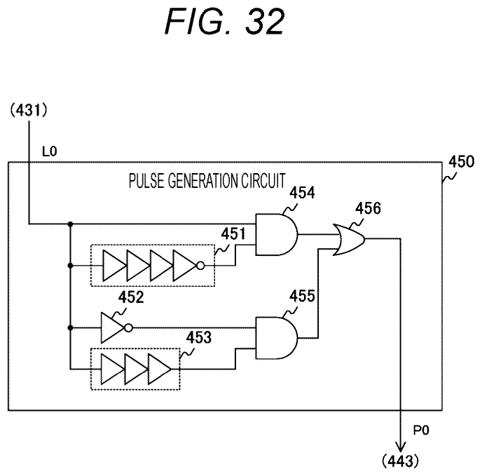

FIG. 32 is a circuit diagram illustrating a configuration example of the pulse generation circuit 450 according to the sixth embodiment of the present technology. The pulse generation circuit 450 includes an inverting delay line 451, an inverter 452, a delay line 453, a logical conjunction (AND) gate 454, an AND gate 455, and a logical disjunction (OR) gate 456.

The inverting delay line 451 delays and inverts the delay signal L0 and supplies the resultant signal to the AND gate 454. The AND gate 454 outputs the logical conjunction of the input delay signal L0 and the inverted signal received from the inverting delay line 451 to the OR gate 456 as a rising pulse signal.

The inverter 452 inverts the delay signal L0 and supplies the resultant signal to the AND gate 455. The inverting delay line 453 delays and inverts the delay signal L0 and supplies the resultant signal to the AND gate 455. The AND gate 455 outputs the logical conjunction of the inverted signal received from the inverter 452 and the signal received from the delay line 453 to the OR gate 456 as a falling pulse signal.

The OR gate 456 outputs the logical disjunction of the rising pulse signal and the falling pulse signal received from the AND gates 454 and 455 to the flip-flop 443 as a pulse signal P0.

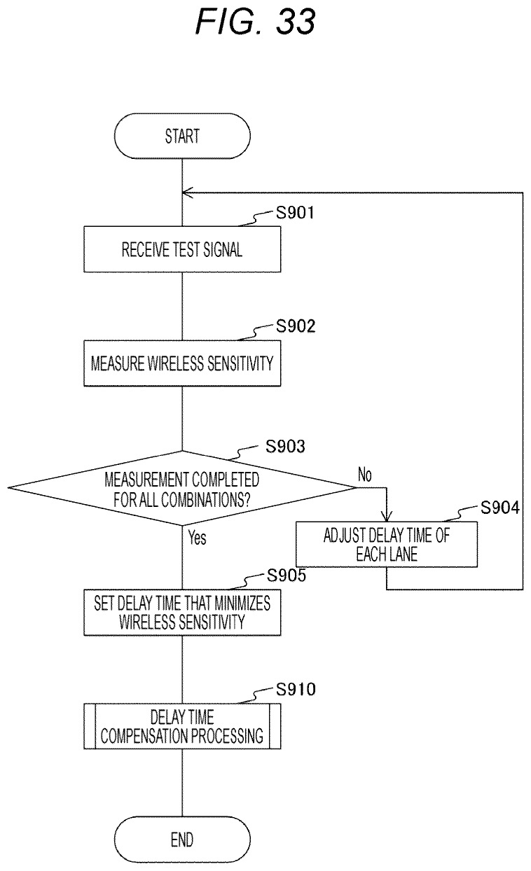

FIG. 33 is a flowchart illustrating an example of the operation of the electronic device 100 according to the sixth embodiment of the present technology. The operation of the electronic device 100 of the sixth embodiment is different from that of the first embodiment in that delay time compensation processing (step S910) is performed after step S905.

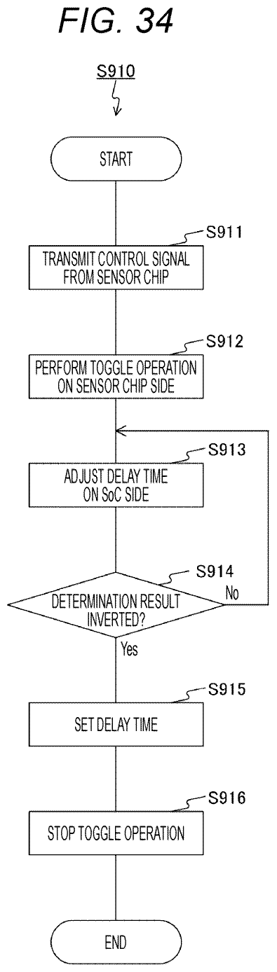

FIG. 34 is a flowchart illustrating an example of the delay time compensation processing according to the sixth embodiment of the present technology. The system control unit 230 in the sensor chip 220 transmits a control signal indicating a magnitude relationship among the delay times of the lanes to the SoC 420 (step S911). Furthermore, the drive unit 225 and the like in the sensor chip 220 perform a toggle operation of inverting a signal within a minimum data cycle for each lane throughout a specific phase compensation period (step S912).

Furthermore, within the phase compensation period, the system control unit 421 in the SoC 420 adjusts the delay time of each lane on the basis of the magnitude relationship among the delay times and the determination result received from the edge inversion determination circuit 440 (step S913). For example, the delay time of Lane 0 is shorter than that of Lane 1. Assuming that the delay time can be switched in multiple levels, the system control unit 421 performs at least one of control to make the delay time of Lane 1 shorter than the default configuration value by one level or control to make the delay time of Lane 0 longer than the default configuration value by one level.

Then, the system control unit 421 on the reception side determines whether or not the determination result indicating the sign of the phase difference between the edges of the two lanes has been inverted (step S914). In a case where there are three lanes, it is determined whether or not all of the three determination results have been inverted.

In a case where any of the determination results has not been inverted (step S914: No), the system control unit 421 repeats step S913 and the subsequent steps. From the second time onward, control is performed to change the delay time by a unit time compared to the previous value. By repeating step S913 until the determination result is inverted, it is possible to reduce the phase difference between the corresponding lanes to approximately zero.

On the other hand, in a case where all the determination results have been inverted (step S914: Yes), the system control unit 421 sets the delay time of each lane (step S915). Then, the sensor chip 220 stops the toggle operation (step S916), and completes the delay time compensation processing.

As illustrated in the drawing, by adjusting the delay time of each lane on the basis of the determination result of the edge relationship on the reception side, it is possible to reset the delay time with high accuracy even in a case where the actual delay time deviates from the design value due to, for example, variations in PVT. Note that, even with a configuration where the transmission side is equipped with a circuit that measures the actual delay time and passes the measured value to the reception side, the delay time can be accurately reset, but this configuration is not preferable because the circuit scale on the transmission side increases.

Note that the second and third embodiments are applicable to the sixth embodiment.

As described above, according to the sixth embodiment of the present technology, the system control unit 421 on the reception side adjusts the delay time of each lane on the basis of the determination result of the edge relationship, so that it is possible to reset the delay time with high accuracy.

### 7. Seventh Embodiment

In the first embodiment described above, the SoC 420 adjusts the delay time of each lane provided between the SoC 420 and the sensor chip 220, but two or more sensor chips may also be installed in the device. An electronic device 100 according to the seventh embodiment is different from that of the first embodiment in that two or more sensor chips are installed and the delay time of each lane provided between the sensor chips is adjusted.

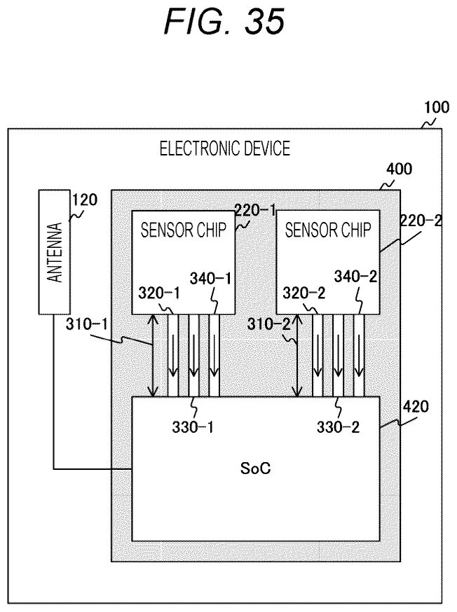

FIG. 35 is a block diagram illustrating a configuration example of the electronic device 100 according to the seventh embodiment of the present technology. The electronic device 100 according to the seventh embodiment includes an antenna 120, a main board 400, a sensor chip 220-1, a sensor chip 220-2, and a SoC 420.

The sensor chips 220-1 and 220-2 are similar in configuration to the sensor chip 220 of the first embodiment. These chips are implemented on the main board 400 together with the SoC 420, for example. Note that, as illustrated in FIG. 2, the sensor chips 220-1 and 220-2 may be placed in a camera module and connected to the main board 400 through a cable.

Furthermore, as illustrated in FIG. 35, transmission lines 310-1, 320-1, 330-1, and 340-1 are laid between the sensor chip 220-1 and the SoC 420. Transmission lines 310-2, 320-2, 330-2, and 340-2 are laid between the sensor chip 220-2 and the SoC 420. These transmission lines are similar to the transmission lines 310, 320, 330, and 340 of the first embodiment. Furthermore, the communication standard applied to the transmission lines 320-1, 330-1, 340-1, 320-2, 330-2, and 340-2 may be the MIPI C-PHY standard as in the first embodiment, or may be a different standard such as the MIPI D-PHY standard. Note that it is also possible to combine a plurality of communication standards, for example, the MIPI C-PHY standard is applied to the sensor chip 220-1, and the MIPI D-PHY standard is applied to the sensor chip 220-2.

In the seventh embodiment, the transmission lines 320-1, 330-1, and 340-1 are denoted as Lanes 0-1, 1-1, and 2-1, respectively, and the transmission lines 320-2, 330-2, and 340-2 are denoted as Lanes 0-2, 1-2, and 2-2, respectively.

Note that the number of chips on the transmission side (the sensor chips 220-1 and 220-2) is two, but may be three or more. In this case, transmission lines are further laid between the third and subsequent chips and the SoC 420.

Furthermore, the sensor chips 220-1 and 220-2 are examples of the first and second chips recited in the claims. Furthermore, the transmission lines 320-1, 330-1, and 340-1 are examples of the first transmission line recited in the claims, and the transmission lines 320-2, 330-2, and 340-2 are examples of the second transmission line recited in the claims.

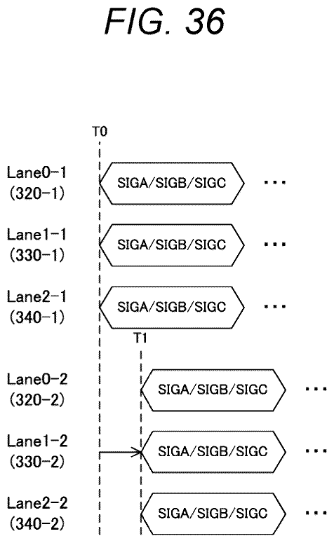

The system control unit 421 (not illustrated) in the SoC 420 can perform the delay time adjustment using any one of the methods illustrated in FIGS. 36, 37, and 38. It is therefore possible to suppress, even in a case where there are two or more chips on the transmission side, electromagnetic interference to enhance wireless sensitivity.

For example, as illustrated in FIG. 36, an output timing of the signal of each of Lanes 0-1, 1-1, and 2-1 is denoted as T0, and an output timing of the signal of each of Lanes 0-2, 1-2, and 2-2 is denoted as T1. SIGA, SIGB, and SIGC in the drawing represent signals transmitted through three lines in each lane.

In the drawing, the system control unit 421 adjusts the delay time of the output timing T1 of Lanes 0-1, 1-1, and 2-1 relative to the output timing TO of Lanes 0-2, 1-2, and 2-2.

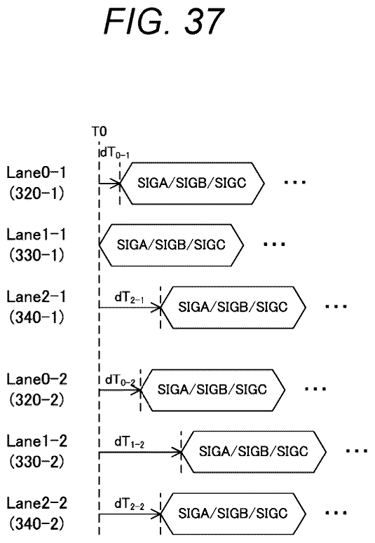

Alternatively, as illustrated in FIG. 37, the system control unit 421 individually adjusts the delay time of each lane. For example, delay times dT₀₋₁, dT₂₋₁, dT₀₋₂, dT₁₋₂, and dT₂₋₂ of Lanes 0-1, 2-1, 0-2, 1-2, and 2-2 relative to the output timing TO of the signal of Lane 1-1 are individually adjusted.

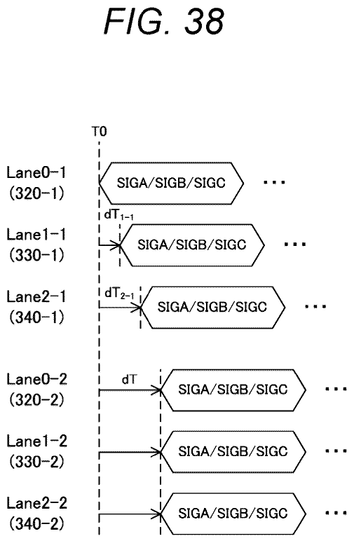

Alternatively, as illustrated in FIG. 38, the system control unit 421 individually adjusts the delay time (dT₁₋₁ or dT₂₋₁) of each of Lanes 0-1, 1-1, and 2-1 and the delay time dT of the output timing T1 of Lanes 0-2, 1-2, and 2-2.

Note that each of the second to sixth embodiments is applicable to the seventh embodiment.

As described above, according to the seventh embodiment of the present technology, the system control unit 421 adjusts the delay time of each transmission line provided between the sensor chips 220-1 and 220-2, so that it is possible to suppress electromagnetic interference with the configuration where there are two or more chips on the transmission side.

### [First Modification]

In the seventh embodiment described above, the system control unit 421 performs the delay time adjustment by controlling each of the sensor chips 220-1 and 220-2. However, some sensor chips are not compatible with the delay control. An electronic device 100 of the first modification of the seventh embodiment is different from that of the seventh embodiment in that authentication is performed for each chip.

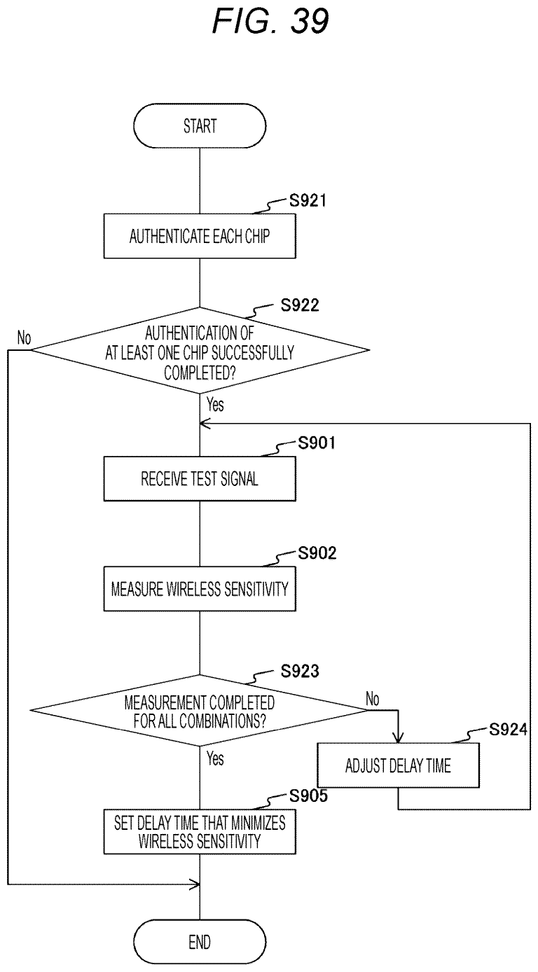

FIG. 39 is a flowchart illustrating an example of the operation of the electronic device 100 according to the first modification of the seventh embodiment of the present technology. In the first modification of the seventh embodiment, an authentication key K1 is pre-stored in a register or the like in the sensor chip 220-1. Furthermore, an authentication key K2 is pre-stored in a register or the like in the sensor chip 220-2. An authentication key K3 is pre-stored a register or the like in the SoC 420. Note that the authentication keys K1, K2, and K3 are examples of the first, second, and third authentication keys recited in the claims.

When the test mode for delay time adjustment is enabled, the sensor chips 220-1 and 220-2 transmit the authentication keys K1 and K2 to the SoC 420. These authentication keys are transmitted through transmission lines 310-1 and 310-2 using, for example, the I2C standard. Note that each sensor chip can also transmit the authentication key through transmission lines 320-1, 330-1, and 340-1 or transmission lines 320-2, 330-2, and 340-2 using, for example, the MIPI C-PHY standard.

Then, the system control unit 421 in the SoC 420 authenticates each of the sensor chips 220-1 and 220-2 on the basis of whether or not a corresponding one of the received authentication keys K1 and K2 matches the authentication key K3 (step S921).

As in the configuration illustrated in FIG. 6, in a case where each sensor chip is equipped with the delay configuration circuit 222, the delay circuit 510, and the like and is compatible with the delay control, a key identical to the authentication key K3 is stored in the chip, thereby ensuring successful authentication. In a case where the authentication keys do not match, or the chip does not transmit the authentication key itself, the authentication fails.

In FIG. 39, the system control unit 421 in the SoC 420 determines whether or not authentication of at least one of the chips has been successfully completed (step S922). In a case where the authentication of at least one of the chips has been successfully completed (step S922: Yes), the electronic device 100 receives the test signal (step S901). Then, the electronic device 100 measures the wireless sensitivity of the antenna 120 (step S902).

The system control unit 421 determines whether or not the measurement of the wireless sensitivity has been completed for all the combinations of the delay times (step S923). In a case where the measurement has not been completed for all the combinations (step S923: No), the electronic device 100 adjusts the delay time of each lane (step S924), and repeats step S901 and the subsequent steps.

In these steps S923 and S924, only the lane corresponding to the chip that has been successfully authenticated has its delay time adjusted. For example, in a case where only one of the sensor chips 220-1 and 220-2 has been successfully authenticated, the system control unit 421 adjusts the delay time of each lane corresponding to the chip and does not adjust the delay times of the other lanes. In a case where both the sensor chips 220-1 and 220-2 have been successfully authenticated, the system control unit 421 performs the delay time adjustment using the method illustrated in FIGS. 36 to 38. As described above, by excluding a chip that has failed authentication (that is, a chip that is incompatible with the delay control) from the adjustment targets, it is possible for chips with various configurations to coexist in the electronic device 100, thereby allowing an increase in versatility.

In FIG. 39, in a case where the measurement has been completed for all the combinations (step S923: Yes), the electronic device 100 sets the delay times that minimize the wireless sensitivity as the final value (step S905). In a case where all the chips have failed authentication (step S922: No), or after step S905, the electronic device 100 terminates the operation in the test mode.

Note that each of the second to sixth embodiments is applicable to the first modification of the seventh embodiment.

As described above, according to the first modification of the seventh embodiment of the present technology, the system control unit 421 adjusts the delay time of the lane corresponding to the chip that has been successfully authenticated, so that it is possible for chips with various configurations to coexist in the electronic device 100.

### [Second Modification]

In the first modification of the seventh embodiment described above, authentication is performed for each chip using the authentication key pre-stored in the chip, but it may be necessary to add or update authentication keys. For example, a chip that is initially incompatible with the delay control may later become compatible through firmware updates or the like. Furthermore, the SoC 420 uses any one of the adjustment methods illustrated in FIG. 36 to 38, but the adjustment method may be changed later. An electronic device 100 according to the second modification of the seventh embodiment is different from that of the first modification of the seventh embodiment in that the authentication key is stored in a rewritable register or the like.

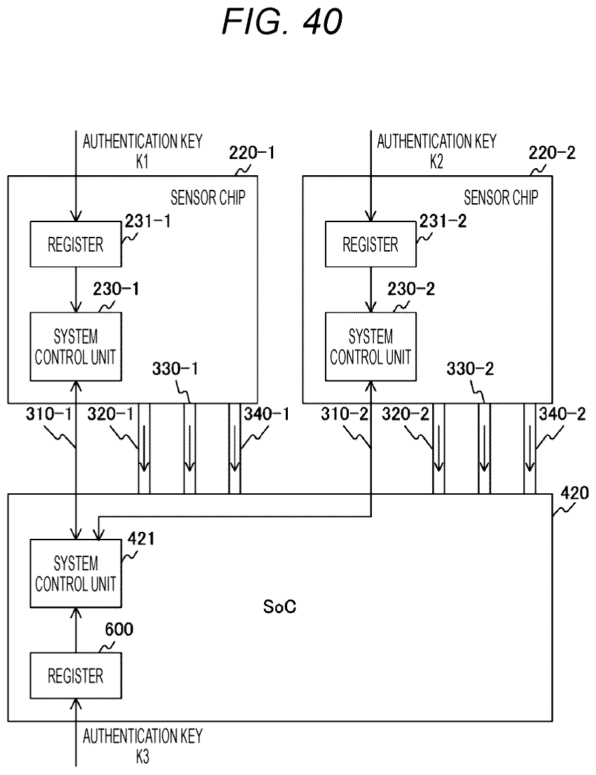

FIG. 40 is a block diagram illustrating a configuration example of the electronic device 100 according to the second modification of the seventh embodiment of the present technology. The electronic device 100 according to the second modification of the seventh embodiment further includes system control units 230-1 and 230-2 and registers 231-1, 231-2, and 600.

The system control unit 230-1 and the register 231-1 are placed in the sensor chip 220-1, and the system control unit 230-2 and the register 231-2 are placed in the sensor chip 220-2. The register 600 is placed in the SoC 420.

The registers 231-1, 231-2, and 600 are rewritable and store the authentication keys K1, K2, and K3, respectively. As these registers, a static random access memory (SRAM) or the like is used. Note that various circuits such as the delay circuit 510 illustrated in FIG. 6 are not illustrated in FIG. 40.

In the test mode, the system control unit 230-1 reads the authentication key K1 from the register 231-1 and transmits the authentication key K1 to the system control unit 421, and the system control unit 230-2 reads the authentication key K2 from the register 231-2 and transmits the authentication key K2 to the system control unit 421. The system control unit 421 reads the authentication key K3 from the register 600 and determines whether or not the authentication key K3 matches each of the authentication keys K1 and K2.

As illustrated in the drawing, the configuration where the authentication keys are stored in the rewritable registers enables updating of the authentication keys as necessary. Furthermore, it is also possible to write the authentication keys later through user software control or the like. Note that the authentication keys are stored in the registers; however, as long as the storage locations are rewritable, they are not limited to the registers and the authentication keys can also be stored in non-volatile memory or the like. Furthermore, the registers 231-1, 231-2, and 600 are examples of the first, second, and third storage units recited in the claims.

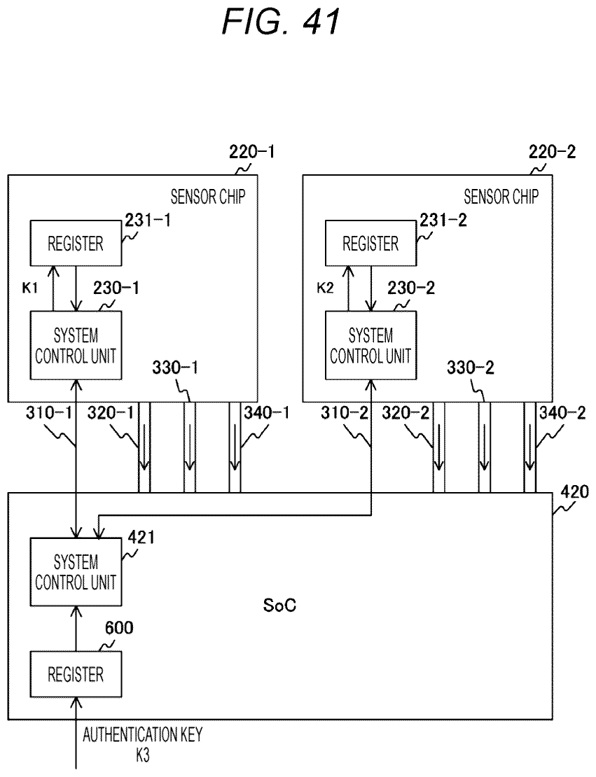

Note that, when the authentication keys are updated, as illustrated in FIG. 41, it is also possible to transmit a new authentication key from the SoC 420 to each sensor chip through the transmission lines 310-1 and 310-2 based on, for example, the I2C standard and store the authentication key in the register in each chip.

Furthermore, each of the second to sixth embodiments is appliable to the second modification of the seventh embodiment.

As described above, according to the second modification of the seventh embodiment of the present technology, each chip stores the corresponding authentication key in the rewritable register, so that it is possible to add or update authentication keys.

### <8. Example of Application to Mobile Entity>

The technology according to the present disclosure (present technology) is applicable to various products. For example, the technology according to the present disclosure may also be implemented as a device mounted on any type of mobile entity such as an automobile, an electric vehicle, a hybrid electric vehicle, a motorcycle, a bicycle, a personal mobility, an airplane, a drone, a vessel, and a robot.

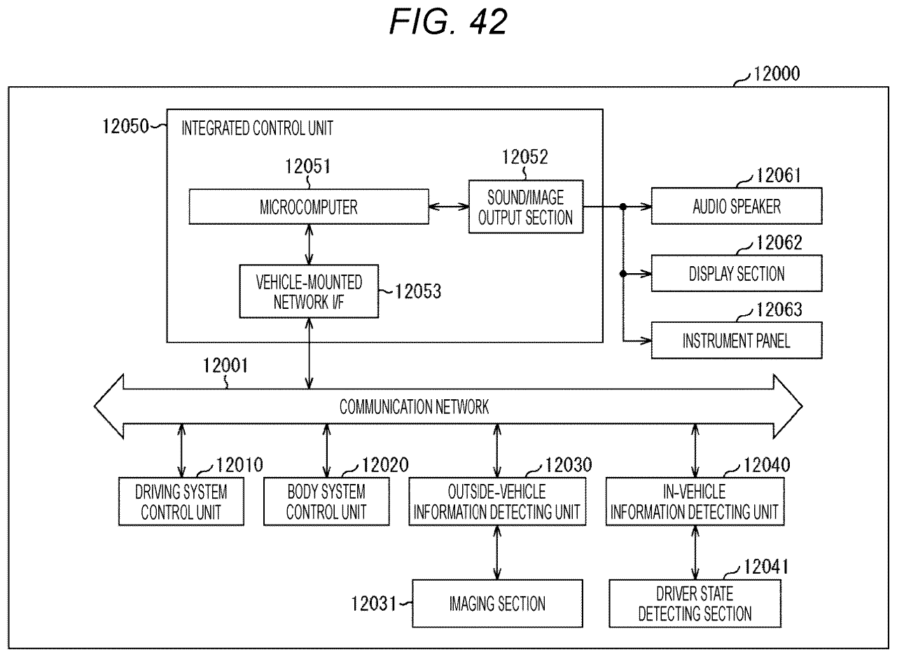

FIG. 42 is a block diagram illustrating a schematic configuration example of a vehicle control system as an example of a mobile entity control system to which the technology according to the present disclosure is applicable.

The vehicle control system 12000 includes a plurality of electronic control units connected to each other via a communication network 12001. In the example illustrated in FIG. 42, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and an in-vehicle network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example illustrated in FIG. 42, an audio speaker 12061, a display section 12062, and an instrument panel 12063 are illustrated as the output device. The display section 12062 may, for example, include at least one of an on-board display and a head-up display.

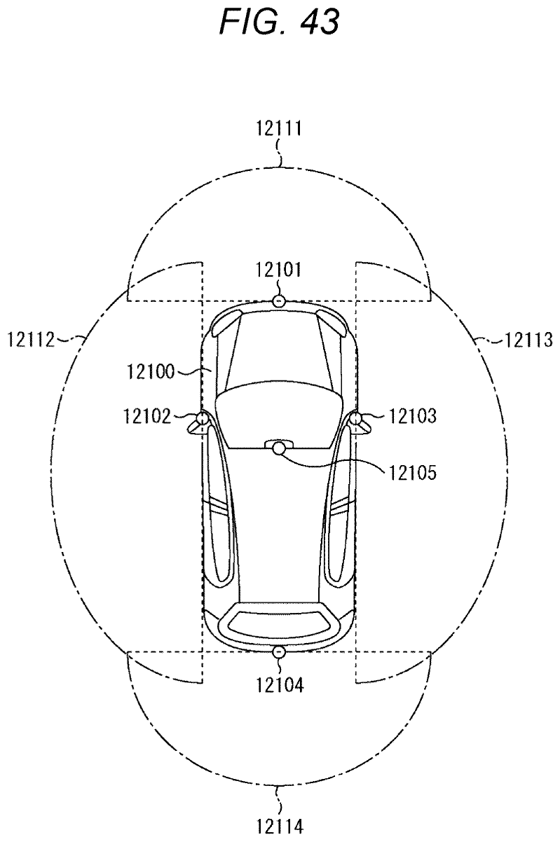

FIG. 43 is a diagram illustrating an example of the installation position of the imaging section 12031.

In FIG. 43, the imaging section 12031 includes imaging sections 12101, 12102, 12103, 12104, and 12105.

The imaging sections 12101, 12102, 12103, 12104, 12105 are provided, for example, at positions such as a front nose, sideview mirrors, a rear bumper, a back door, and an upper portion of a windshield within the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 43 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, an example has been described of the vehicle control system to which the technology according to the present disclosure is applicable. The technology according to the present disclosure is applicable to, for example, the vehicle control system 12000 among the above-described components. Specifically, the electronic device 100 illustrated in FIG. 4 is applicable to the vehicle control system 12000. By applying the technology according to the present disclosure to the vehicle control system 12000, it is possible to suppress electromagnetic interference to enhance the wireless sensitivity of the antenna, and it is therefore possible to enhance the reliability and safety of the system.

Note that the embodiments have been described as examples for embodying the present technology, and the matters in the embodiments and the matters defining the invention in the claims have correspondence relationships. Similarly, the matters defining the invention in the claims and the matters with the same names in the embodiments of the present technology have correspondence relationships. Note that the present technology is not limited to the embodiments, and can be embodied by applying various modifications to the embodiments without departing from the gist of the present technology.

Note that the effects described herein are merely examples and are not intended to be limiting, and other effects may also be achieved.

Note that the present technology may also have the following configurations.
(1) An electronic device including:
an antenna;
a plurality of transmission lines through which signals are transmitted; and
a control unit that controls directivity of electromagnetic waves radiated from the plurality of transmission lines on the basis of reception performance of the antenna.
(2) The electronic device according to the above (1), further including:
a first drive unit that outputs a first output signal;
a second drive unit that outputs a second output signal;
a first transmission-side delay circuit that delays output of the first output signal; and
a second transmission-side delay circuit that delays output of the second output signal, in which
the plurality of transmission lines includes:
a first transmission line through which the first output signal is transmitted; and
a second transmission line through which the second output signal is transmitted, and
the control unit adjusts a delay time of each of the first and second transmission-side delay circuits.
(3) The electronic device according to the above (2), in which
each of the first and second transmission-side delay circuits includes:
multi-stage delay elements that generate a plurality of delay signals with different delay times; and
a selector that selects and outputs either a clock signal or one of the plurality of delay signals.
(4) The electronic device according to the above (2), in which
each of the first and second transmission-side delay circuits includes:
a logic circuit that outputs a signal obtained by delaying a clock signal;
a plurality of first transistors connected in parallel between a power supply terminal of the logic circuit and a power supply node; and
a plurality of second transistors connected in parallel between a ground terminal of the logic circuit and a ground node, and
the control unit controls a number of the first transistors in an ON state and a number of the second transistors in the ON state.
(5) The electronic device according to the above (2), in which
each of the first and second transmission-side delay circuits includes:
a logic circuit that delays and outputs a clock signal;
a first transistor inserted between a power supply terminal of the logic circuit and a power supply node;
a second transistor inserted between a ground terminal of the logic circuit and a ground node;
a first bias voltage generation circuit that generates a first bias voltage and supplies the first bias voltage to a gate of the first transistor; and
a second bias voltage generation circuit that generates a second bias voltage and supplies the second bias voltage to a gate of the second transistor, and
the control unit controls each of the first and second bias voltages.
(6) The electronic device according to any one of the above (2) to (5), in which
a communication standard applied to the plurality of transmission lines includes a mobile industry processor interface (MIPI) C-PHY standard.
(7) The electronic device according to the above (2), further including:
a first reception-side delay circuit that delays and outputs the first output signal as a first delay signal;
a second reception-side delay circuit that delays and outputs the second output signal as a second delay signal;
a first receiver circuit that receives the first delay signal; and
a second receiver circuit that receives the second delay signal, in which
the control unit further adjusts a delay time of each of the first and second reception-side delay circuits.
(8) The electronic device according to the above (7), in which
a communication standard applied to the plurality of transmission lines includes a MIPI D-PHY standard.
(9) The electronic device according to the above (7) or (8), in which
the control unit includes:
a transmission-side control unit that adjusts the delay time of each of the first and second transmission-side delay circuits and supplies a control signal related to the delay time; and
a reception-side control unit that adjusts the delay time of each of the first and second reception-side delay circuits on the basis of the control signal.
(10) The electronic device according to the above (9), in which
each of the first and second reception-side delay circuits includes a delay locked loop (DLL).
(11) The electronic device according to the above (9), or (10) further including
an edge inversion determination circuit that determines whether or not a sign of a phase difference between an edge of the first delay signal and an edge of the second delay signal has been inverted and outputs a determination result, in which
the reception-side control unit adjusts the delay time of each of the first and second reception-side delay circuits on the basis of the control signal and the determination result.
(12) The electronic device according to the above (1), in which
a communication standard applied to the plurality of transmission lines includes a standard applied to transmission of differential signals or single-ended signals.
(13) The electronic device according to the above (12), in which
the communication standard applied to transmission of the differential signals includes peripheral component interconnect express (PCIe), and the communication standard applied to transmission of the single-ended signals includes double data rate (DDR).
(14) The electronic device according to any one of the above (1) to (13), in which
the plurality of transmission lines includes:
a predetermined number of first transmission lines through which signals are transmitted from a first chip to the control unit; and
a predetermined number of second transmission lines through which signals are transmitted from a second chip to the control unit.
(15) The electronic device according to the above (14), in which
output timings of the signals transmitted through each of the predetermined number of first transmission lines are identical,
output timings of the signals transmitted through each of the predetermined number of second transmission lines are identical, and
the control unit adjusts a delay time of the output timings of either the first transmission lines or the second transmission lines relative to the other transmission lines.
(16) The electronic device according to the above (14), in which
the control unit individually adjusts a delay time of the signals transmitted through each of the predetermined number of first transmission lines and the predetermined number of second transmission lines.
(17) The electronic device according to the above (14), in which
output timings of the signals transmitted through each of the predetermined number of second transmission lines are identical, and
the control unit individually controls a delay time of the output timings and a delay time of the signals transmitted through each of the predetermined number of first transmission lines.
(18) The electronic device according to any one of the above (14) to (17), in which
the first chip transmits a first authentication key,
the second chip transmits a second authentication key, and
the control unit authenticates each of the first and second chips on the basis of whether or not each of the first and second authentication keys matches a third authentication key, and controls directivity of electromagnetic waves radiated from transmission lines corresponding to a chip that has been successfully authenticated.
(19) The electronic device according to the above (18), further including
a rewritable third storage unit that stores the third authentication key, in which
the first chip includes a rewritable first storage unit that stores the first authentication key, and
the second chip includes a rewritable second storage unit that stores the second authentication key.
(20) A control method for an electronic device, the control method including:
measuring a parameter indicating reception performance of an antenna; and
controlling, on the basis of the parameter, directivity of electromagnetic waves radiated from a plurality of transmission lines through which signals are transmitted.

### REFERENCE SIGNS LIST

100 Electronic device
110 Casing
120 Antenna
200 Camera module
201 Module head
202 Module board
210, 415 Discrete component
211 Lens
220, 220-1, 220-2 Sensor chip
221 Data generation unit
222, 430 Delay configuration circuit
223, 224, 431 to 433, 510 Delay circuit
225 to 227 Drive unit
230, 230-1, 230-2, 421 System control unit
231-1, 231-2, 600 Register
300 FPC cable
301, 302 Ground line
310, 310-1, 310-2, 320, 320-1, 320-2, 330, 330-1, 330-2, 340, 340-1, 340-2 Transmission line
321 to 323, 331 to 333, 341 to 343 Signal line
400 Main board
410 Connector
420 SoC
422 to 424 Receiver circuit
425 Communication circuit
426 to 428 Synchronization circuit
429 Data processing unit
440 Edge inversion determination circuit
441, 442, 450 Pulse generation circuit
443 to 445 Flip-flop
451 Inverting delay line
452, 511 to 524, 549 Inverter
453 Delay line
454, 455 Logical conjunction (AND) gate
456 Logical disjunction (OR) gate
525 Selector
531 to 539 pMOS transistor
540 to 548 nMOS transistor
550 P-channel bias voltage generation unit
551 N-channel bias voltage generation unit
560, 565, 566 DLL
561 Phase comparator
562 Shift register
563 Variable delay line
564 Replica delay line
590, 595, 596 Drive circuit
591 Serializer
592 Pre-driver
593 Final driver
12000 Vehicle control system

1. An electronic device comprising:
an antenna;
a plurality of transmission lines through which signals are transmitted; and
a control unit that controls directivity of electromagnetic waves radiated from the plurality of transmission lines on a basis of reception performance of the antenna.

2. The electronic device according to claim 1, further comprising:
a first drive unit that outputs a first output signal;
a second drive unit that outputs a second output signal;
a first transmission-side delay circuit that delays output of the first output signal; and
a second transmission-side delay circuit that delays output of the second output signal, wherein
the plurality of transmission lines includes:
a first transmission line through which the first output signal is transmitted; and
a second transmission line through which the second output signal is transmitted, and
the control unit adjusts a delay time of each of the first and second transmission-side delay circuits.

3. The electronic device according to claim 2, wherein
each of the first and second transmission-side delay circuits includes:
multi-stage delay elements that generate a plurality of delay signals with different delay times; and
a selector that selects and outputs either a clock signal or one of the plurality of delay signals.

4. The electronic device according to claim 2, wherein
each of the first and second transmission-side delay circuits includes:
a logic circuit that outputs a signal obtained by delaying a clock signal;
a plurality of first transistors connected in parallel between a power supply terminal of the logic circuit and a power supply node; and
a plurality of second transistors connected in parallel between a ground terminal of the logic circuit and a ground node, and
the control unit controls a number of the first transistors in an ON state and a number of the second transistors in the ON state.

5. The electronic device according to claim 2, wherein
each of the first and second transmission-side delay circuits includes:
a logic circuit that delays and outputs a clock signal;
a first transistor inserted between a power supply terminal of the logic circuit and a power supply node;
a second transistor inserted between a ground terminal of the logic circuit and a ground node;
a first bias voltage generation circuit that generates a first bias voltage and supplies the first bias voltage to a gate of the first transistor; and
a second bias voltage generation circuit that generates a second bias voltage and supplies the second bias voltage to a gate of the second transistor, and
the control unit controls each of the first and second bias voltages.

6. The electronic device according to claim 2, wherein
a communication standard applied to the plurality of transmission lines includes a mobile industry processor interface (MIPI) C-PHY standard.

7. The electronic device according to claim 2, further comprising:
a first reception-side delay circuit that delays and outputs the first output signal as a first delay signal;
a second reception-side delay circuit that delays and outputs the second output signal as a second delay signal;
a first receiver circuit that receives the first delay signal; and
a second receiver circuit that receives the second delay signal, wherein
the control unit further adjusts a delay time of each of the first and second reception-side delay circuits.

8. The electronic device according to claim 7, wherein
a communication standard applied to the plurality of transmission lines includes a MIPI D-PHY standard.

9. The electronic device according to claim 7, wherein
the control unit includes:
a transmission-side control unit that adjusts the delay time of each of the first and second transmission-side delay circuits and supplies a control signal related to the delay time; and
a reception-side control unit that adjusts the delay time of each of the first and second reception-side delay circuits on a basis of the control signal.

10. The electronic device according to claim 9, wherein
each of the first and second reception-side delay circuits includes a delay locked loop (DLL).

11. The electronic device according to claim 9, further comprising
an edge inversion determination circuit that determines whether or not a sign of a phase difference between an edge of the first delay signal and an edge of the second delay signal has been inverted and outputs a determination result, wherein
the reception-side control unit adjusts the delay time of each of the first and second reception-side delay circuits on a basis of the control signal and the determination result.

12. The electronic device according to claim 1, wherein
a communication standard applied to the plurality of transmission lines includes a standard applied to transmission of differential signals or single-ended signals.

13. The electronic device according to claim 12, wherein
the communication standard applied to transmission of the differential signals includes peripheral component interconnect express (PCIe), and the communication standard applied to transmission of the single-ended signals includes double data rate (DDR).

14. The electronic device according to claim 1, wherein
the plurality of transmission lines includes:
a predetermined number of first transmission lines through which signals are transmitted from a first chip to the control unit; and
a predetermined number of second transmission lines through which signals are transmitted from a second chip to the control unit.

15. The electronic device according to claim 14, wherein
output timings of the signals transmitted through each of the predetermined number of first transmission lines are identical,
output timings of the signals transmitted through each of the predetermined number of second transmission lines are identical, and
the control unit adjusts a delay time of the output timings of either the first transmission lines or the second transmission lines relative to the other transmission lines.

16. The electronic device according to claim 14, wherein
the control unit individually adjusts a delay time of the signals transmitted through each of the predetermined number of first transmission lines and the predetermined number of second transmission lines.

17. The electronic device according to claim 14, wherein
output timings of the signals transmitted through each of the predetermined number of second transmission lines are identical, and
the control unit individually controls a delay time of the output timings and a delay time of the signals transmitted through each of the predetermined number of first transmission lines.

18. The electronic device according to claim 14, wherein
the first chip transmits a first authentication key,
the second chip transmits a second authentication key, and
the control unit authenticates each of the first and second chips on a basis of whether or not each of the first and second authentication keys matches a third authentication key, and controls directivity of electromagnetic waves radiated from transmission lines corresponding to a chip that has been successfully authenticated.

19. The electronic device according to claim 18, further comprising
a rewritable third storage unit that stores the third authentication key, wherein
the first chip includes a rewritable first storage unit that stores the first authentication key, and
the second chip includes a rewritable second storage unit that stores the second authentication key.

20. A control method for an electronic device, the control method comprising:
measuring a parameter indicating reception performance of an antenna; and
controlling, on a basis of the parameter, directivity of electromagnetic waves radiated from a plurality of transmission lines through which signals are transmitted.
